(19) United States
(12) Patent Application Publication
(10) Pub. No.: US 2026/0342608 A1
(43) Pub. Date: Oct. 29, 2026

(54) Customizable Automations for Network-Connected Devices

(71) Applicant: Google LLC, Mountain View, CA (US)

(72) Inventors: Robert Clarke Harris, Longboat Key, FL (US); Mohammad Aleagha, Redwood City, CA (US); Noel Billig, Redwood City, CA (US); Brian Sanford Solomon, Montclair, NJ (US)

(73) Assignee: Google LLC, Mountain View, CA (US)

(21) Appl. No.: 19/117,939

(22) PCT Filed: Oct. 3, 2023
(86) PCT No.: PCT/US2023/075872

§ 371 Date: Apr. 2, 2025

Related U.S. Application Data
(60) Provisional application No. 63/413,191, filed on Oct. 4, 2022.

(51) Int. Cl. H04L 12/28; G06F 3/0482

(52) U.S. Cl. CPC H04L 12/282; G06F 3/0482; H04L 2012/2849; H04L 2012/285

(57) ABSTRACT

This document describes systems and techniques directed at customizable automations for network-connected devices. In aspects, a device management system presents a starter input having a trigger menu and a detecting device menu. The device management system receives user input indicative of a selected trigger and a detecting device from one or more of the menus. The device management system also presents an action input having an action menu and an action device menu. The device management system receives user input indicative of a selected action and a selected action device. Based on the selections, the device management system associates the selected trigger with the selected action such that, responsive to the selected trigger being detected by the selected detecting device, the selected action is performed by the selected action device.

### PRIORITY CLAIM AND INCORPORATION BY REFERENCE

This application claims the benefit of U.S. Provisional Patent Application Ser. No. 63/413,191, filed Oct. 4, 2022, the disclosure of which is hereby incorporated by reference.

### BACKGROUND

Many people equip their homes with network-controlled lights, appliances, media devices, cameras, locks, and other types of devices. A popular feature of systems used to manage these network-controlled devices is the ability to coordinate actions. For example, multiple lighting sources within a room can be instructed by a single command. However, most systems have limited, preset functions to achieve these actions. Users often desire more control and flexibility when controlling network-controlled devices.

### SUMMARY

This document describes systems and techniques for customizable automations for network-connected devices. In aspects, a device management system presents a starter input having a trigger menu and a detecting device menu. The device management system receives user input indicative of a selected trigger and a detecting device from one or more of the menus. The device management system also presents an action input having an action menu and an action device menu. The device management system receives user input indicative of a selected action and a selected action device. Based on the selections, the device management system associates the selected trigger with the selected action such that, responsive to the selected trigger being detected by the selected detecting device, the selected action is performed by the selected action device.

In an example, a method is described in which a starter input is presented. The starter input includes a trigger menu having at least one trigger detectable by one of a plurality of detecting devices available within a device management system and a detecting device menu having at least one of the plurality of detecting devices. A selected trigger is received from the trigger menu and a selected detecting device is received from the detecting device menu. An action input is presented. The action input includes an action menu having at least one action performable by one of a plurality of action devices available within the device management system and an action device menu having at least one of the plurality of action devices. A selected action is received from the action menu and a selected action device is received from the action device menu, the selected action device being configured to perform the selected action. The selected trigger is associated with the selected action such that, responsive to the selected trigger being detected by the selected detecting device, the selected action is performed by the selected action device.

In another example, a method of a device management system is described that detects a plurality of network-connected devices, the plurality of network-connected devices comprising at least one wireless communication device having a display. Based on the detection, wireless network communication is relayed between at least two devices of the plurality of network-connected devices. The wireless network communication is sufficient to control one or more other network-connected devices of the plurality of network-connected devices. At the wireless communication device, a user interface associated with the device management system is displayed, the user interface having one or more widgets. At the user interface, the one or more widgets are grouped by at least one category, each widget of the one or more widgets associated with at least one network-connected device of the plurality of detected network-connected devices. The one or more widgets configured to provide at least one of: an action functionality, the action functionality comprising an instruction for the at least one network-connected device associated with the widget to perform an action; an automation functionality, the automation functionality comprising at least one trigger and at least one action, activation of the at least one trigger sufficient to cause the at least one action by the at least one network-connected device associated with the widget; or image data, the image data comprising one or more images captured at an image sensor of the at least one network-connected device associated with the widget.

In another example, a method is described that displays, at a display of an electronic device, a user interface associated with a device management system configured to control a plurality of network-connected devices, the user interface having a first region and a second region. A plurality of images is obtained from at least one network-connected device of the plurality of network-connected devices. Displayed in the first region of the user interface are a first set of images including at least one image from the plurality of images, a horizontal timeline, and a horizontal time indicator, the horizontal time indicator configured to transition with respect to the horizontal timeline. Displayed in the second region of the user interface are a vertical timeline and a vertical time indicator on the vertical timeline, the vertical timeline configured to transition with respect to the vertical time indicator. The horizontal time indicator is transitioned with respect to the horizontal timeline at a first rate and with a first displacement. In response to the transitioning, in the first region of the user interface, a second set of images is displayed including at least another image from the plurality of images, the second set of images corresponding to a location of the horizontal time indicator on the horizontal timeline. The first rate corresponds to a number of images of the plurality of images between the first set of images and the second set of images that are displayed per second while transitioning the horizontal time indicator with respect to the horizontal timeline. The first displacement corresponds to a distance that the horizontal time indicator transitioned with respect to the horizontal timeline.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features nor limit the scope of the claimed subject matter.

### BRIEF DESCRIPTION OF THE DRAWINGS

The details of one or more aspects of systems and techniques for a customizable user interface for a device management system are described in this document with reference to the following drawings. The same numbers are used throughout the drawings to reference like features and components:

FIG. 1A illustrates an example network environment having a plurality of network-connected devices controllable by a device management system in accordance with one or more implementations;

FIG. 1B illustrates a representative operating environment in which the device management system facilitates interconnectivity between and control of a plurality of network-connected devices in accordance with one or more implementations;

FIG. 2 illustrates an example favorites screen presented on the client device in accordance with one or more implementations;

FIG. 3 illustrates an example devices screen presented on the client device in accordance with one or more implementations;

FIGS. 4A-4B, 5A-5D, 6A-6C, and 7 illustrate example widgets to control lighting devices;

FIGS. 8A-8E illustrate example widgets to control heating and cooling devices;

FIGS. 9A-9C illustrate example widgets to control media devices;

FIGS. 10A-10C illustrate example techniques provided by the device management system to create and/or execute automations that direct the operation of various devices based on specified conditions;

FIGS. 11A-11C illustrate example widgets configured to present image data and/or provide controls for image-capturing network-connected devices;

FIG. 12 illustrates an example cameras space to access image data;

FIGS. 13A and 13B illustrate example techniques for user-customization of the favorites screen of FIG. 2;

FIGS. 14A and 14B illustrate example techniques to modify placements of widgets on the favorites screen of FIG. 2;

FIG. 15 illustrates an example customized space created by a user;

FIGS. 16A and 16B illustrate example techniques to create the customized space of FIG. 15;

FIG. 17 illustrates an example technique to access an enhanced image interface;

FIGS. 18A and 18B illustrate example implementations of the enhanced image interface;

FIG. 19 illustrates image data captured by a front camera;

FIG. 20 illustrates an example front camera event log accessible by a user of the device management system via a client device;

FIGS. 21A and 21B illustrates example techniques to present representative thumbnail images of one or more events;

FIGS. 22-31 illustrate example techniques for a user to interact with the enhanced image interface;

FIG. 32 illustrates example components and features of the device management system, including an automation creation system;

FIG. 33 illustrates a schematic diagram of example devices, as well as actions that each device is configured to perform and/or triggers that each device is configured to detect;

FIGS. 34-49, 52, and 53 illustrate an example automation creation interface presented by the automation creation system to create automation routines;

FIGS. 50 and 51 illustrate an example operation of the automation routine created and activated as described with reference to FIGS. 34-48;

FIG. 54 illustrates an example annotated automation creation interface including instructions and default parameters;

FIG. 55 illustrates an example automations screen including the automation routine created as described with reference to FIGS. 34-49, 52, and 53;

FIG. 56 illustrates an example method for enabling users to selectively create groups of devices as described with reference to FIGS. 1-16B;

FIG. 57 illustrates an example method of controlling a display of images obtained from at least one network-connected device as described with reference to FIGS. 17-31; and

FIG. 58 illustrates an example method of receiving an automation routine via an automation creation interface.

### DETAILED DESCRIPTION

### Overview

A device management system enhances a user's ability to organize and control network-connected devices. For instance, via the device management system, a user can selectively group controls for network-connected devices, navigate between “spaces” within a user interface, and control network-connected devices associated with a “group”. In implementations, the user interface may include a tab or a control tile associated with a group so that, by selecting the tab or control tile, the user is presented with widgets enabling them to access and/or control the network-connected devices associated with the group. A respective space may include “favorites”, which the user may access and/or desire to access most readily or frequently so that the user need not navigate through all of their network-connected devices to access their favorites. In still further implementations, the user interface may include spaces associated with a particular physical space or theme. For example, a user may create a “backyard” space to group widgets associated with network-connected devices in the backyard. Such network-connected devices may include lights, audio devices, cameras, and so on. In another example, a user may create a “pets” space to group widgets associated with network-connected devices used to monitor or assist their pets. Such network-connected devices may include cameras directed to physical spaces that the pets commonly occupy, devices that provide water to the pets, speakers that enable the user to remotely speak to their pets, and so on. In some implementations, display windows (e.g., presenting a video feed) may be included in these spaces to provide easy access to images collected by cameras.

When accessing image data from one or more cameras, a video interface may provide users a unified ability to perform rapid and/or detailed scrubbing through images in sets of image data. The images may be represented on a dynamic timeline that is proportionate to the available image data, rather than representing sets of available image data (where image data may be captured upon detection of movement or other events) on a fixed timeline. For example, periods of time for which no image data is collected may be collapsed on the timeline, while periods of time for which image data has been collected are displayed along a vertically displayed timeline. The user may then advance rapidly through the sets of image data displayed on the vertical timeline by scrolling or “scrubbing” along the vertical timeline. Alternately, within a set of image data displayed on the vertical timeline, if the user desires to scrub more slowly through the image data, the user may manipulate a horizontally displayed timeline to scrub through just that particular set of image data. Thus, on a single interface, the user may perform vertical, rapid scrubbing through all the sets of image data collected on the interface by engaging and manipulating a vertical timeline and may perform horizontal, detailed scrubbing by engaging and manipulating a horizontal timeline.

To grant even further control of network-connected devices, a script editor provides an interface that assists creation of automations. In the script editor, users can select starters that may identify one or more triggers to initiate a particular action of one or more network-connected devices. For example, if the user chooses to create an automation that turns on one or more lighting devices at a particular time or in response to a particular event, the user is presented with a list of the different types of triggers that are detectable by the network-connected devices so that the user need not memorize device or trigger identifiers and manually type in commands to create a starter. Instead, the user can simply use the starter from the presented list. In implementations, the user may be prompted to select or enter triggers so that if, for example, a user wants the lighting devices to be turned on at a particular time or when another network-connected device is activated, the user may select the desired triggers by selecting from a list. Correspondingly, the user may then identify the desired actions, such as which lighting devices or other network-connected devices should be activated or deactivated in response to the starter. Again, the available actions may be presented in list form so that the user can select the actions from a list without having to memorize or type device names and associated actions. In further implementations, a user may be provided with controls to adjust parameters of network-connected devices, such as a light color, a color temperature, a brightness, or other attributes. Once completed, the automation is activated so selected actions can be performed in response to an occurrence of specified starters. In this way, the script editor provides users simplified manners in which to create automations without being limited to predetermined routines. Moreover, users can be spared from needing to create a procedure involving multiple network-connected devices through less-intuitive processes than the script editor.

This document describes systems and techniques for a customizable user interface for a device management system. In aspects, a user interface of a device management system includes one or more widgets grouped by at least one category. Each widget of the one or more widgets is associated with at least one network-connected device and is configured to provide an image, enable selection of an action, or present an automation function. Widgets can be organized within spaces to enhance user experience.

### Interface Providing for Customized Spaces

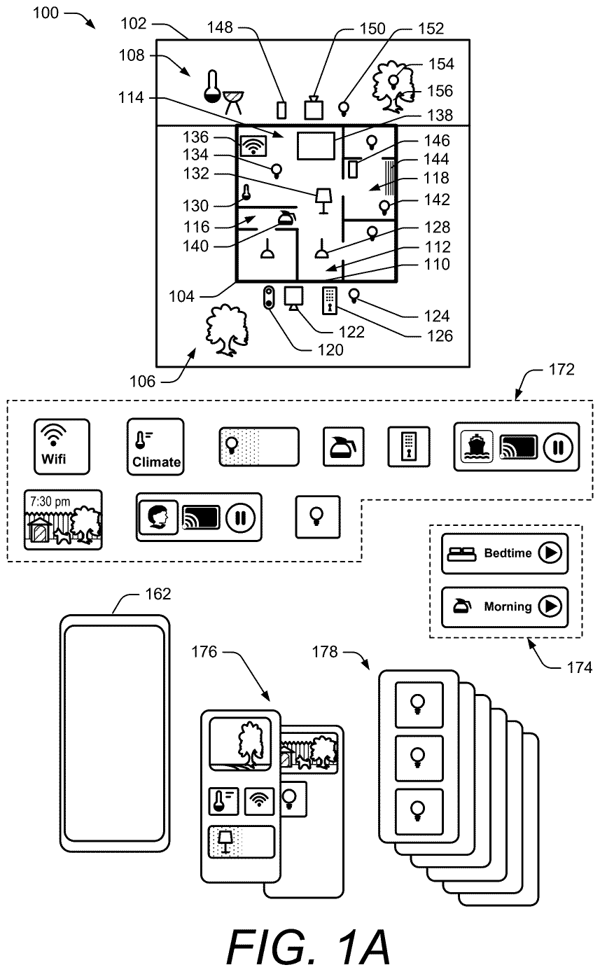

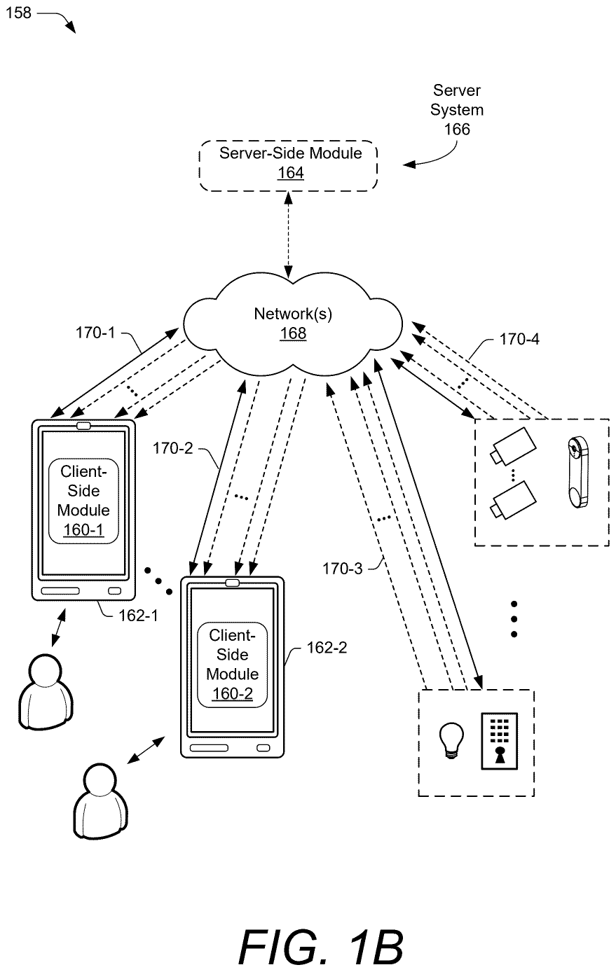

FIG. 1A illustrates an example network environment 100 having a plurality of network-connected devices controllable by a device management system in accordance with one or more implementations. In the example of FIG. 1, the network environment 100 includes the plurality of network-connected devices situated within a home property 102, including a housing structure 104, a front yard 106, and a backyard 108. The housing structure 104 includes a front door 110, a front entryway 112, a great room 114, a kitchen 116, a bedroom 118, and other rooms and spaces. It will be appreciated by one skilled in the art that although FIG. 1A illustrates a home property 102, such as a single-family home, the present teachings are also applicable, without limitation, to duplexes, townhomes, multi-unit apartment buildings, hotels, retails stores, office buildings, industrial buildings, and more generally any work space or living space.

In the network environment 100, any number of the network-connected devices can be implemented for wireless interconnection to wirelessly communicate and interact with each other. The network-connected devices can be modular, intelligent, multi-sensing, network-connected devices that can integrate seamlessly with each other and/or with a central server or a cloud-computing system to provide any of a variety of useful automation objectives and implementations.

As illustrated, the home property 102 is equipped with many network-connected devices situated within the housing structure 104, the front yard 106, and/or the backyard 108. For example, at the front door 110, there is a doorbell 120, a camera 122 (which may be combined with the doorbell 120 or may be a separate device), an outside light 124, and a front door lock 126. The entryway 112 includes an entryway light 128. The great room 114 includes a thermostat 130, a lamp 132, an overhead light 134, a WiFi access point 136, and a smart television 138. The kitchen 116 includes a coffeemaker 140. The bedroom 118 includes a light, 142, automated blinds 144, and a smart speaker/media player 146. The backyard 108 includes a media player 148, a camera 150, an outside light 152, and decorative lights 154 positioned in a tree 156.

In implementations, one or more of the network-connected devices are learning devices. For example, the thermostat 130 may include a Nest® Learning Thermostat that detects ambient climate characteristics (e.g., temperature and/or humidity) and controls an HVAC system in the network environment 100. The learning thermostat and other network-connected devices can “learn” by capturing occupant settings to the devices. For instance, the thermostat 130 learns preferred temperature set-points for mornings and evenings, and when the occupants of the housing structure 104 are asleep or awake, as well as when the occupants are typically away or at the home property 102.

Any of the network-connected devices in the network environment 100 can serve as low-power and communication nodes to create, for example, a home area network (HAN) in the network environment 100. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the home area network. The network-connected devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy sensor and/or an ambient light sensor can detect an occupant in a room as well as measure the ambient light, and activate the light source when the ambient light sensor detects that the room is dark and when the occupancy sensor detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the network-connected devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the network environment 100. In other implementations, the network environment 100 can be used to automatically turn on and off lighting units as a person moves from room to room in the structure. For example, the network-connected devices can detect the person's movement through the housing structure 104 and communicate corresponding messages via the nodes of the network environment 100. Using the messages that indicate which rooms are occupied, other network-connected devices that receive the messages can activate and/or deactivate accordingly. As referred to above, the network environment 100 can also be utilized to provide exit lighting in the event of an emergency, such as by turning on the appropriate lighting units that lead to a safe exit. The light units may also be turned on to indicate the direction along an exit route that a person should travel to safely exit the housing structure 104.

The various network-connected devices may also be implemented to integrate and communicate with wearable computing devices to, for example, identify and locate an occupant of the housing structure 104 and adjust a temperature, lighting, sound system, or the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the housing structure 104 or network environment 100.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

Consider, momentarily, FIG. 1B, which illustrates a representative operating environment 158 in which the device management system facilitates interconnectivity between and control of a plurality of network-connected devices in accordance with one or more implementations. As shown in FIG. 1B, the operating environment 158 includes a client-side module 160 (e.g., a first client-side module 160-1, a second client-side module 160-2) implemented on one or more client devices 162 (e.g., smartphones, wireless communication devices) and, optionally, a server-side module 164 implemented on a server system 166. In implementations, the client-side module and/or the server-side module 164 receive sensor data (e.g., image data, audio data) and/or device data (e.g., metadata, numerical data) from one or more network-connected devices. In some implementations, the device data may be analyzed to provide context for events (e.g., motion events). In additional implementations, the device data indicates that an audio event (e.g., detected by an audio device such as an audio sensor integrated in the network-connected device), a security event (e.g., detected by a perimeter monitoring device such as a motion sensor), a hazard event (e.g., detected by the hazard detector), medical event (e.g., detected by a health-monitoring device), or the like has occurred within a network environment 100.

Multiple accounts may be linked to a single network environment 100. For example, multiple occupants of a network environment 100 may have accounts linked to the network environment 100. In some implementations, each account is associated with a particular level of access and each account can have personalized notification settings. In additional implementations, a single account is linked to multiple network environments 100 (e.g., multiple different HANs). For example, a person may own or occupy, or be assigned to review and/or govern, multiple network environments 100. In some implementations, the account has distinct levels of access and/or notification settings for each network environment.

In some implementations, one or more network-connected devices capture video and send the captured video to the server system 166, including the server-side module 164, and/or the client-side module 160 substantially in real-time. In further implementations, each image-capturing network-connected device has its own on-board processing capabilities to perform some preliminary processing on the captured video data before sending image data (e.g., along with metadata obtained through the preliminary processing) to a controller device and/or the server system 166. In some implementations, one or more of the image-capturing network-connected devices are configured to locally store the image data (e.g., for later transmission if requested by a user). In some implementations, a respective image-capturing network-connected device is configured to perform some processing of the captured image data and, based on the processing, either send the image data in substantially real-time, store the image data locally, or disregard the image data.

The client-side module 160 can communicate with the server-side module 164 executed on the server system 166 through the one or more networks 168. In some implementations, the client-side module 160 provides all functionality for the device management system. In additional implementations, the client-side module 160 provides client-side functionality for the device management system 158, while the server-side module 164 provides server-side functionality for the device management system 158.

The server system 166 can include one or more processors, a storage database, an input/output (I/O) interface to one or more client devices 162 (e.g., a first client device 162-1, a second client device 162-2), and an I/O interface to one or more network-connected devices. The I/O interface to one or more client devices 162 may facilitate the client-facing input and output processing. The storage database may store a plurality of profiles for accounts registered with the device management system 158, where a respective user profile includes account credentials for a respective account, and one or more video sources linked to the respective account. The storage database may further store raw video data received from the video sources, as well as various types of device data, including metadata, lightbulb brightness, lightbulb color, age of network-connected devices, motion events, event categories, event categorization models, event filters, event masks, and so on. The I/O interface to one or more video sources may facilitate communications with one or more video sources (e.g., groups of one or more doorbells, cameras, and associated controller devices).

Examples of a representative client device 162 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an eBook reader, or a combination of any two or more of these data processing devices or other data processing devices.

Examples of the one or more networks 168 include local area networks (LAN) and wide area networks (WAN) such as the Internet. The one or more networks 168 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

In some implementations, the server system 166 is implemented on one or more standalone data processing apparatuses or a distributed network of computers. The server system 166 may also employ various virtual devices and/or services of third-party service providers (e.g., third-party cloud service providers) to provide the underlying computing resources and/or infrastructure resources of the server system 166. In some implementations, the server system 166 includes, but is not limited to, a server computer, a handheld computer, a tablet computer, a laptop computer, a desktop computer, or a combination of any two or more of these data processing devices or other data processing devices.

The operating environment 158 shown in FIG. 1B includes both a client-side portion (e.g., the client-side module) and a server-side portion (e.g., the server-side module); however, in alternative implementations, the operating environment 158 of the device management system may only include a client-side module or a server-side module. As described herein, the term “device management system” refers to the software and/or hardware used to enable network-connected device control and interconnectivity, including at least one of the client-side module 160, the server-side module 164, one or more antennas, one or more processors, or so on.

The division of functionality between the client and server portions of the device management system can vary in different implementations. Similarly, the division of functionality between a network-connected device (e.g., client device 162-1) and the server system 166 can vary in different implementations. For example, in some implementations, the client-side module is a thin-client that provides only user-facing input and output processing functions, and delegates all other data processing functionality to a backend server (e.g., the server system 166). Similarly, in some implementations, a respective one of the network-connected device is a simple video capturing device that continuously captures and streams video data to the server system 166 with limited or no local preliminary processing on the video data. Although many aspects of the present technology are described from the perspective of the server system 166, the corresponding actions performed by a client device 162 and/or the network-connected devices would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the server system 166, a client device 162, and a network-connected device cooperatively.

In some aspects, network-connected devices, including client devices 162, transmit one or more streams 170 (e.g., a first stream 170-1, a second stream 170-2, a third stream 170-3, a fourth stream 170-4) of instructions, sensor data, and/or device data directly between each other and/or to the server system 166. In some implementations, the one or more streams include multiple streams, having respective resolutions and/or quality.

Turning back to FIG. 1A, one or more of the network-controlled devices (e.g., network-controlled devices 120, 122, 124, 126, 128, 130, 132, 134, 136, 138, 140, 142, 144, 146, 148, 150, 152, and 154) may be associated with and controllable by one or more widgets 172 presented on a user interface, for example, on the client-side module 160 of the device management system. One or more of the network-controlled devices may also be associated with and controllable by one or more automation widgets 174 presented on the user interface, for example, on the client-side module 160 of the device management system. In implementations, the one or more automation widgets 174 control a routine or an automation that correlates functions of relevant network-connected devices, as further described below. The client device 162 supports software (not shown in FIG. 1A) that is adapted to detect each of the network-controlled devices and to support control of these devices with the appropriate widgets 172 and 174.

It will be appreciated that, because each of the network-controlled devices are associated with one or more of the widgets 172 and 174, the widgets 172 and 174 may populate one or more screens 176 of the client-side module 160 presented on the client device 162. This may make finding and accessing one or more desired widgets 172 and 174 cumbersome and slow. However, in various implementations, a user is able to group sets of one or more of the widgets 172 and 174 into spaces 178, such as a favorites space and one or more other user-created spaces that the user can organize to suit their preferences and priorities. As further described below, the user then may select one of these spaces and, in turn, have ready access to the desired widget or widgets without scrolling through many screens to reach the desired one.

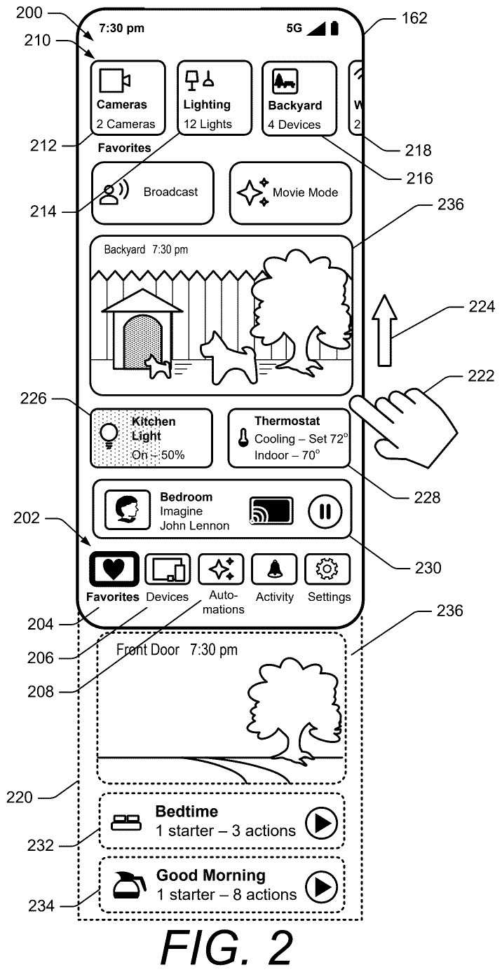

FIG. 2 illustrates an example favorites screen 200 presented on the client device 162 (e.g., a wireless communication device with a display). The favorites screen 200 is presented on the client device 162 by the client-side module 160 (e.g., an application). The favorites screen 200, and other screens, as further described below, includes a set of tabs 202 that includes, for example, a favorites tab 204 that provides access to the favorites screen 200. A devices tab 206 provides access to a devices screen that includes available widgets for network-connected devices in the device management system. An automations tab 208 provides access to an interface to create or edit automations and routines, as further described below.

The favorites screen 200 may also include a set of control tiles 210 that provide access to groups of widgets collected by type, such as a cameras tile 212 or a lighting tile 214 that provide access to all of the cameras and lighting devices, respectively. In addition, a backyard tile 216 represents a custom space created by the user to provide access to a selected group of devices. As the name suggests, the user has created a custom space for some of the devices in the backyard 108 (FIG. 1) of the home property 102. By selecting the backyard tile 216, the user is able to access a screen that presents those devices on a single screen to conveniently access those devices, as further described below. The set of control tiles 210 may be scrollable (e.g., horizontally) to access additional control tiles for additional spaces (represented by the edge of an additional control tile 218 on the edge of the favorites screen 200 which may be accessed by, for example, horizontally scrolling across the set of control tiles 210).

In some implementations, the favorites screen 200 may be regarded as a custom space because the user may edit which widgets (e.g., widgets 172 and 174) and/or in what order the widgets are presented on the favorites screen 200. Accordingly, a favorites tile could be included in the set of control tiles 210. However, because the favorites screen 200 is accessible by selecting the favorites tab 204 from the set of tabs 202, a control tile for the favorites screen 200 may not be necessary.

In some implementations, the favorites screen 200 is user-customizable, enabling users to include widgets that they use or prefer the most. In additional implementations, the favorites screen 200 is customized based on user activity (e.g., often-selected widgets). In still further implementations, the favorites screen 200 is customized based on machine-learned preferences. For example, the device management system can include a machine-learned model, configured to analyze habits of a user. In this way, if the user routinely checks one or more widgets at 9:00 P.M. to confirm doors are locked, the machine-learned model can present, on the favorites screen 200, widgets associated with locks at or around that time.

The favorites screen 200, and other custom spaces, may be scrollable (e.g., vertically) so as to present additional widgets, which may otherwise not fit on a single screen. This is represented in FIG. 2 by an extended area 220 marked in dotted lines below the favorites screen 200. For example, the extended area 220 may be accessed by vertically scrolling through the favorites screen 200 by engaging the screen with a digit 222 and moving the digit 222 in a vertical direction 224. In implementations, the set of tabs 202 and/or the set of control tiles 210 may be configured to remain present on the favorites screen 200 or screens of other custom spaces as the user scrolls through other widgets associated with those screens.

For example, the favorites screen 200 includes a kitchen light widget 226 that the user may have included because they want ready access to control a kitchen light. The favorites screen 200 also includes a thermostat widget 228 to provide ready access to climate controls. The favorites screen 200 also includes a media widget 230 to provide ready access to a bedroom media player. The extended area 220 of the favorites screen 200 includes additional automation widgets 232 and 234 to access automations that control bedtime and good morning routines, respectively.

In addition to widgets 226, 228, and 230 and automations widgets 232 and 234, the favorites screen 200 (and other spaces, as described below), also may include one or more image widgets to provide direct access to cameras included in the device management system. A backyard image widget 236 shows images collected by the backyard camera 150 and a front door image widget 238 shows images collected by the front door camera 122 (see FIG. 1). The image widgets 236 and 238 may show current images collected by the respective cameras 150 and 122, respectively, and may be manipulated to rewind through previously-captured images, as described further below. By including the image widgets 236 and 238 on the favorites screen 200 (or in other custom spaces) a user is able to access the image data without having to access a separate camera interface.

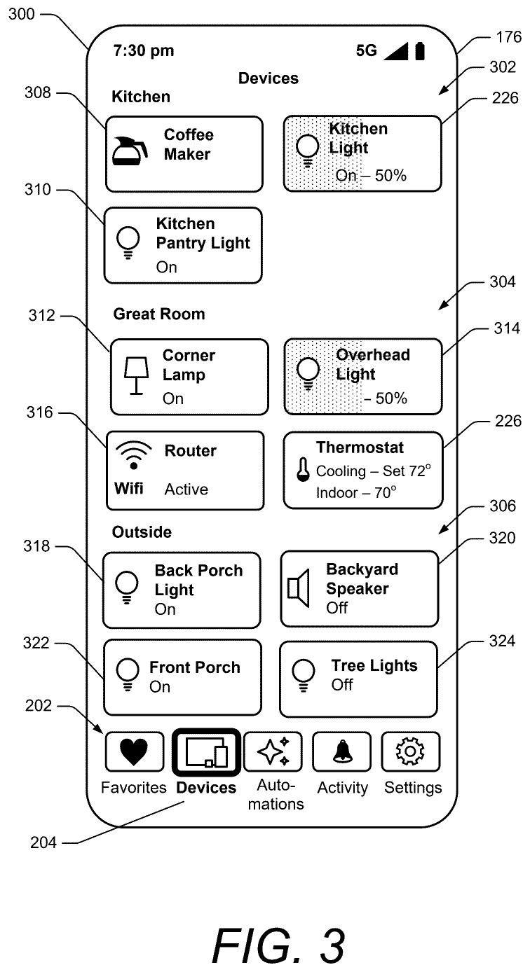

In implementations, a user may access a devices screen that includes widgets for one or more devices included in the device management system by selecting the devices tab 206. FIG. 3 illustrates an example devices screen 300 in accordance with one or more implementations. As illustrated, the devices screen 300 may include the devices in groups 302, 304, and 306, according to an area within the home property 102 in which the devices are situated and/or associated with. In additional or alternative implementations, the widgets may be arranged alphabetically according to device name, or in some other sequence. As with the favorites screen 200, the devices screen 300 may include more widgets than may fit within a single screen. Widgets not included on a first screen of the devices screen 300 may be accessed by scrolling the devices screen 300 comparably to how the user may scroll through the favorites screen 200 as described with reference to FIG. 2.

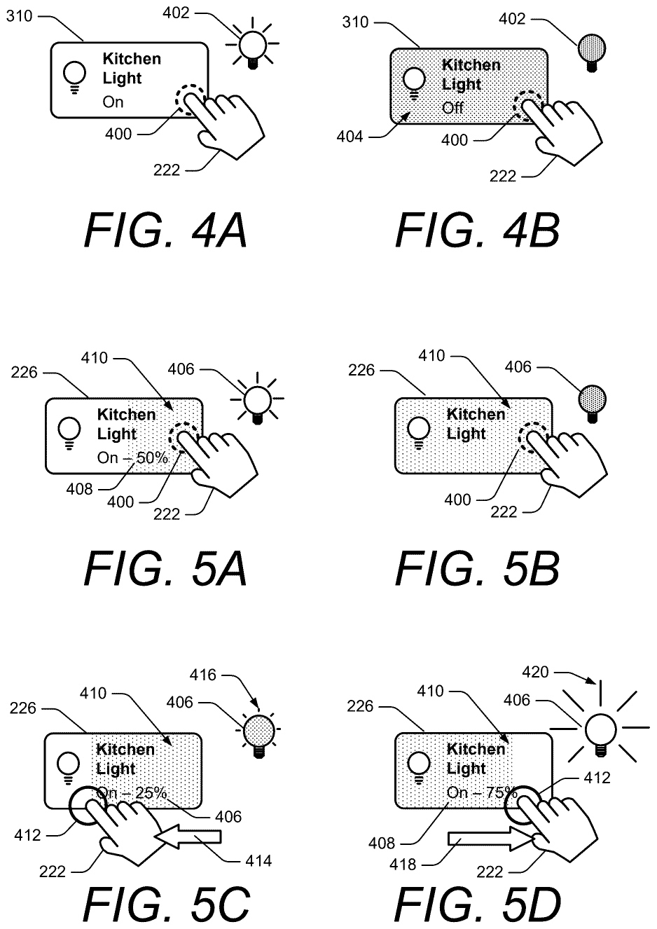

For example, a kitchen group 302 includes a coffee maker widget 308, the kitchen light widget 226, which was also included on the favorites screen 200 (see FIG. 2), and a kitchen pantry light widget 310. It will be appreciated that the kitchen light widget 226 is different from the kitchen pantry light widget 308; different devices, even different lighting devices may offer different functionality and, thus, may have different widgets, as described further below with reference to FIGS. 4A-5D. In implementations, the groups 302, 304, and 306 of the devices screen 300 may include within each of the groups 302, 304, and 306, widgets for all of the devices included in the area for the respective group. Thus, the kitchen group 302 includes all of the network-connected devices in the kitchen 116 of the home (see FIG. 1). However, if the user were to choose to create a kitchen space, as further described below, the user may elect to include only a subset of the widgets 226, 308, and 310. In implementations, as shown in FIG. 3, the widgets within each group are ordered alphabetically.

A great room group 304 includes a corner lamp widget 312, an overhead light widget 314, a router widget 316, and the thermostat widget 228 that, like the kitchen light widget 226, was included on the favorites screen 200. An outside group 306 includes a back porch light widget 318, a backyard speaker widget 320, a front porch light widget 322, and a tree lights widget 324. In implementations, the devices screen 300 may be configured in various ways. For example, the groups 302, 304, and 306 may be selected by the user when devices are added to the device management system. Devices may be added to pre-determined groups or the user may add a custom group name. For example, the outside group 306 may be a default group or may be selected by the user; alternatively, the user may have selected to create separate groups for front yard devices and backyard devices. Devices may be automatically added to a group according to the name of the device, so that the kitchen light widgets 226 and 310 are added to the kitchen group 302 automatically. On the other hand, the user may have to identify that the coffee maker widget 308 should be assigned to the kitchen group 302.

It should be noted that in the foregoing figures and the figures to follow, devices are shown as being controlled by the client device 162, in the nature of a mobile telephone. However, it should also be noted that the devices may be controlled by a computer, by a smart display, by an application executing on a streaming television device, from a smartwatch, or by any user interface device configured to operate with the device management system.

As previously mentioned, different devices offer different functions and, thus, may be controlled by widgets that offer different functions. FIGS. 4A-4B, 5A-5D, 6A-6C, and 7 illustrate examples of different types of widgets that may be used to control different lighting devices. FIGS. 4A and 4B depict a basic lighting widget such as used for the kitchen pantry widget 310. It will be appreciated that some light bulbs or other lighting devices have one color and are not dimmable, such as a basic light-emitting diode (LED) bulb, which may be well-suited for a closet such as a kitchen pantry. For such devices for which the only control is on or off, as shown in FIG. 4A, the basic lighting widget for the kitchen pantry light 310 may be tapped (as represented by a dotted circle 400 under the digit 222) to switch the associated lighting device 402 to an on position (as represented by radiant lines extending from the lighting device 402). As shown in FIG. 4B, the basic lighting widget for the kitchen pantry light 310 may be tapped again to switch the associated lighting device 402 to an off position (as represented by the lighting device 402 being grayed). A background color or intensity 404 may change to signify when the lighting device 402 is turned off.

By contrast, some light bulbs or other lighting devices may offer different colors or color temperatures and may be dimmable, set to pulse, alternate colors, or perform other lighting functions. For a dimmable device, such as kitchen lights, the light may be turned off and on or dimmed. As shown in FIG. 5A, the dimmable kitchen light widget 226 may be tapped (as represented by the dotted circle 400 under the digit 222) to switch the associated lighting device 406 to an on position (as represented by radiant lines extending from the lighting device 406). In implementations, when a dimmable light is turned on, the kitchen light widget 226 may recall a previous brightness level, as reflected by the kitchen light widget 226 showing a brightness level indicator 408. In addition, a background 410 may be partially shaded to illustrate a brightness level. As shown in FIG. 5B, the dimmable lighting widget for the kitchen light widget 226 may be tapped again to switch the associated lighting device 406 to an off position (as represented by the lighting device 406 being grayed). With the lighting device switched off, the brightness level indicator 408 (FIG. 5A) is removed from the kitchen light widget 226. Also, the background 410 is now fully shaded to show the lighting device 406 is off.

In addition, as shown in FIG. 5C, to decrease the brightness of the lighting device 406, the digit 222 may press and hold the kitchen light widget 226 (as represented by a solid circle 412 under the digit 222) while sliding the digit 222 in a first direction 414 which, in this example, is to the left. As a result, the brightness of the lighting device 406 is dimmed (as represented by shortened radiant lines 416 extending from the lighting device 406). The brightness level indicator 408 and the background 410 of the kitchen light widget 226 are both changed to represent the dimming of the lighting device 406. Correspondingly, as shown in FIG. 5D, to increase the brightness of the lighting device 406, the digit 222 may press and hold the kitchen light widget 226 while sliding the digit 222 in a second direction 418 which, in this example, is to the right. As a result, the brightness of the lighting device 406 is increased (as represented by lengthened radiant lines 420 extending from the lighting device 406).

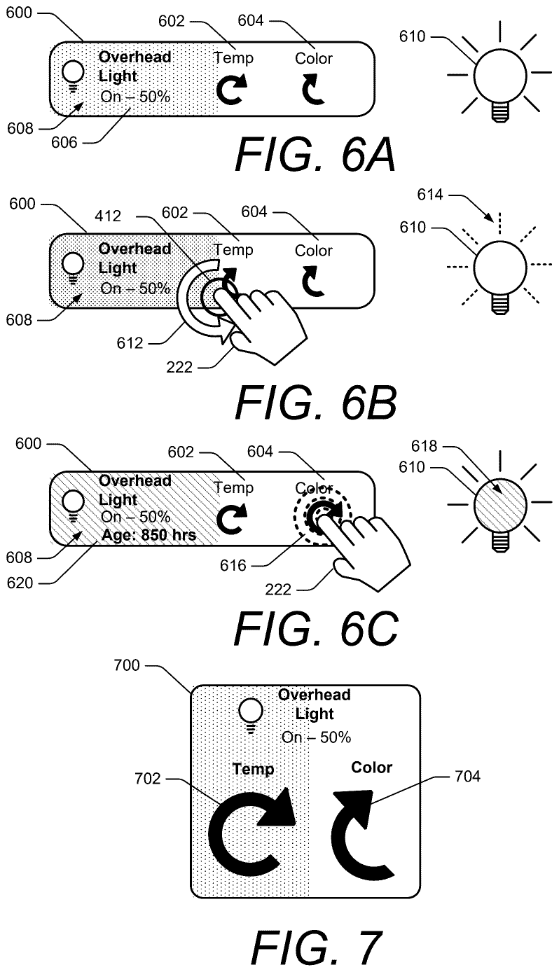

Referring to FIGS. 6A-6C, a widget 600 for a lighting device that also features adjustable color temperature or color may incorporate controls 602 and 604 to manage these functions. The widget 600 may also include dimming controls as previously described with reference to FIGS. 5C and 5D and, thus, may include a brightness level indicator 606 and a changeable background 608 to reflect changes in the brightness level, which may be controlled as described with reference to FIGS. 5C and 5D. The widget 600 also may allow a lighting device 610 to be controlled by tapping the widget 600 to turn the lighting device 610 on and off, as described with reference to FIGS. 5A and 5B. A color temperature control 602 may enable the user to change a temperature of a light, such as changing the lighting device 610 from a daylight white to a soft or warm white. A color control 604 may enable the user to change the color of the lighting device 610 from red to violet and colors in between. In implementations, the changeable background 608 may change to reflect different color temperatures or colors selected using the controls 602 and 604.

Referring to FIG. 6B, the color temperature may be changed by holding the digit 222 on the color temperature control 602 (as represented by the solid circle 412) and moving the digit in a circular motion 612 to change the color temperature up or down, with the color temperature changing as represented by radiant lines 614 extending from the lighting device changing to a dotted pattern. The changeable background 608 may reflect the changed color temperature by displaying a corresponding fill pattern. Instead of moving the digit 222 in a circular pattern to change lighting parameters, referring to FIG. 6C, the color may be changed by repeatedly tapping the digit 222 on the color temperature control 604 (as represented by concentric dotted circles 616) to cycle through the color options, with the color temperature changing as represented by a fill pattern 618 of the lighting device 610 changing. The changeable background 608 may reflect the changed color temperature by displaying a corresponding fill pattern. A combination of moving the digit in a circle about the controls 602 and 604 or tapping the controls 602 and 604 may be used.

In implementations, a lighting control widget also may be configured to show an age of a lighting device, such as a light bulb. The lighting device may be configured to monitor its usage, or the device management system (see FIG. 1) may be configured to track the usage. An age indicator 820 thus may report the usage (in time used, time in place, etc.) of the lighting device so that the user may consider whether the lighting device is nearing an end of its usable life and should be replaced.

Alternatively, given the small size of the widget 600, tapping one of the controls 602 or 604 may invoke a control window 700, as shown in FIG. 7. The control window 700 may overlay the screen (not shown in FIGS. 6A-6C and 7) on which the widget is displayed. The control window may present an enlarged color temperature control 702 and an enlarged color control 704 to facilitate user manipulation. The color temperature control 702 and the color control 704 of the control window 700 may be manipulated by using a digit to rotate the controls, as previously described, or the control window 700 may include a linearly slidable control for one or both of the color temperature control 702 and the color control 704. The control window 700 may include dimming options as previously described with reference to FIGS. 5C and 5D as well as the color temperature control 702 and the color control 704.

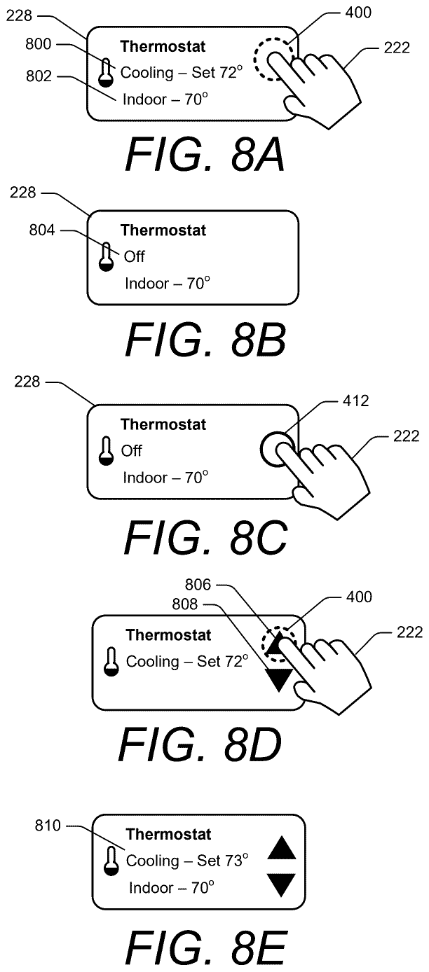

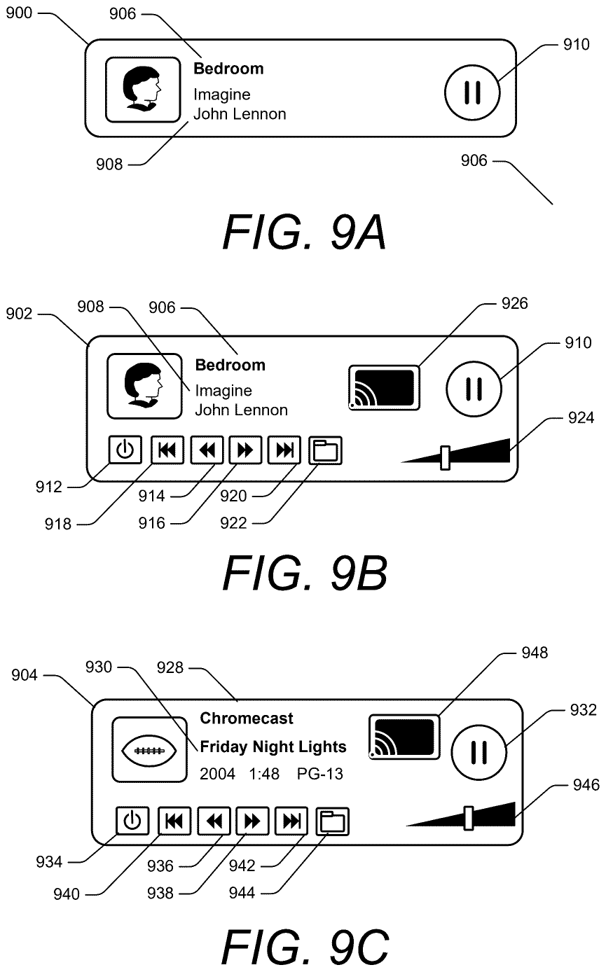

In addition to controlling the functions of lighting devices, Widgets may provide control for any number of properties of any number or type of devices. Just for example, FIGS. 8A-8E show a widget 900 for controlling climate control systems and FIGS. 9A-9C show widgets 900, 902, and 904 for controlling media devices. However, although only a few examples are described here, other widgets may be provided to control fans, appliances, cleaning devices, or any number of network-connected devices or systems.

Referring to FIG. 8A, the thermostat widget 228 that was included on the favorites screen 200 (see FIG. 2) enables a user to control climate systems, such as a home's heating and cooling systems. The thermostat widget 228 may report a current system setting 800 which, in the example of FIG. 8A, is “Cooling—Set 72o.” The thermostat widget 228 may report a current state or temperature 802 which, in the example of FIG. 8A, is “Indoor—70o.” The thermostat widget 228 may be tapped (as represented by the dotted circle 400 under the digit 222) to turn the heating and cooling system off. FIG. 8B represents the heating and cooling system being turned off by the user's input of FIG. 8A, showing a system status 804 of “Off.”

Referring to FIG. 8C, the thermostat widget 228 may offer additional functionality which the user may engage by pressing and holding (as represented by the solid circle 412 under the digit 222) the widget 228. Referring to FIG. 8D, responsive to the input of FIG. 8C, the thermostat widget 228 may present a temperature increase input 806 and a temperature decrease input 808. By, for example, by tapping on the temperature increase input 805 (as represented by the dotted circle 400 under the digit 222), the user may increase the temperature setting of the thermostat. (If the heating and cooling system had been turned off, as previously described, invoking the temperature increase input 806 or the temperature decrease input 808 may reactivate the heating and cooling system.) Referring to FIG. 8E, the thermostat widget 228 reports an updated setting 810 of “Cooling—Set 73o.” It should be appreciated that the thermostat widget 228 may always present the temperature increase input 806 and the temperature decrease input 808 and the user may not have to take any action to have the inputs 806 and 808 presented by the widget 228.

FIG. 9A-9C show different media control widgets 900, 902, and 904 to control network-attached media devices incorporated in the device management system. A basic audio control widget 900 may display a name of the media device (“media device name 906”), a graphical and/or textual identifier of the media being played 908, and a play/pause toggle control 910. Referring to FIG. 9B, a more robust audio control widget 902 includes the same media device name 906, media identifier 908, and play/pause control 910, as well as other controls. For example, the widget 902 may also include a power on/off control 912, a rewind control 914, a fast forward control 916, a previous track button 918, a next track button 920, and a file button 922 to access available media. The widget also may include a volume control 924 and a cast control 926 to control whether the specified media device should cast its content to another playback device (or, if the device is receiving a cast stream, to stop the cast stream). Referring to FIG. 9C, a video control widget 904 includes analogous controls, but is directed to controlling a video device rather than an audio device. The widget thus includes a device name 928, a media identifier 930, a play/pause control 932, a power on/off control 934, a rewind control 936, a fast forward control 938, a previous section button 940, a next section button 942, and a file button 944 to access available media. The widget also may include a volume control 946 and a cast control 948 to control whether the specified media device should cast its content to another playback device (or, if the device is receiving a cast stream, to stop the cast stream).

Although the preceding discussion with reference to FIGS. 4A-9C describe lighting devices, heating and cooling devices, and media devices in particular, it will be evident to those skilled in the art that similar controls can be provided for other network-connected devices, including coffee makers, refrigerators, garage door openers, cleaning assistants, ovens, water facets, door hinges, and so on.

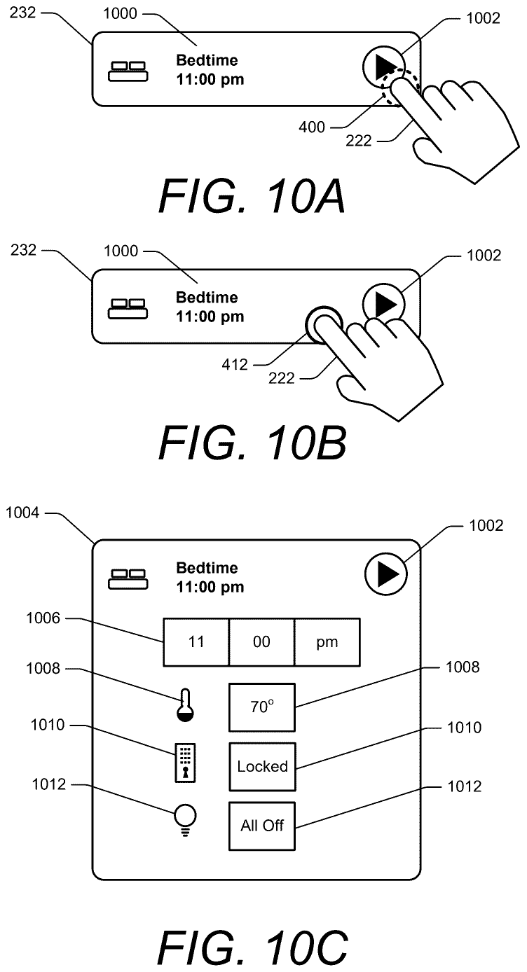

FIG. 10A-10C illustrate example techniques provided by the device management system to create and/or execute automations that direct the operation of various devices based on specified conditions. Although these automations may execute automatically in response to the specified conditions, a user may wish to manually initiate or stop an automation. Accordingly, widgets 1000, 1002, and 1004 may enable a user to intervene in the operation of an automation. FIGS. 10A and 10B depicts the bedtime automation widget 232 included on the favorites screen 200 (see FIG. 2). Referring to FIG. 10A, the bedtime automation widget 232 includes identifying information 1000 that identifies the automation and/or may identify a time or other trigger that initiates an associated automation. The bedtime automation widget 232 also may include an override button 1002 that enables a user to manually initiate the bedtime automation or to pause or cancel execution of the bedtime automation. The user may override the automation by tapping on the override button 1002 with the digit 222 (as signified by the dotted circle 400 beneath the digit 222).

Referring to FIG. 10B, in implementations, if the user presses and holds the automation widget 232 with a digit 222 (as signified by the solid circle 412 beneath the digit 222), an options window 1004 as shown in FIG. 10C may be invoked to change the automation. The options window 1004, which also may include the override button 1002, may also identify parameters used by the bedtime automation, such as a time 1006 when the automation is initiated, a list of devices 1008, 1010, and 1012 included in the bedtime automation, and one or more parameters 1014, 1016, and 1018 of the corresponding devices 1008, 1010, and 1012, respectively. In implementations, a user may thus alter a current implementation of the bedtime automation without editing the automation, as described further below.

As previously described, in implementations, the favorites screen 200 (FIG. 2) or other spaces may include a widget in the form of image widgets 236 and 238 that provides direct access to images received from one or more cameras directly on the favorites screen or in another space. In addition to presenting the image data directly from the favorites screen 200 or another space, the image widgets 236 and 238 also enable the user to directly engage the image data presented by the image widgets 236 and 238 without having to engage a separate camera interface.

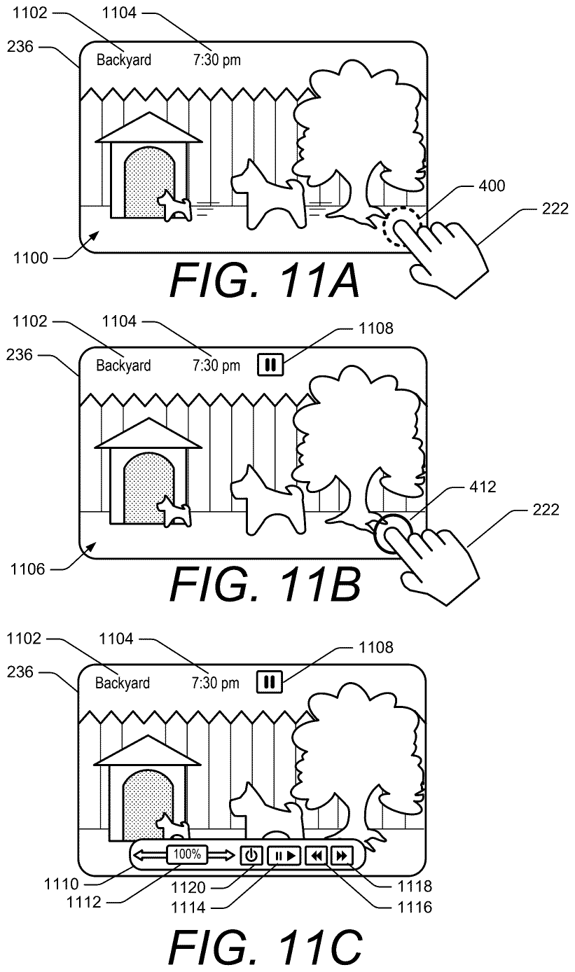

FIG. 11A-11C illustrate example widgets configured to present image data and/or provide controls for image-capturing network-connected devices. Referring to FIG. 11A, the image widget 236 shows an image 1100 of the backyard 108 of the home property 102 captured by the backyard camera 150 (see FIG. 1), which may include a series of images captured as part of a video. The image widget 236 also presents a source identifier 1102 indicating that the image 1100 is of the backyard 108 and a time 1104 when the image 1100 was captured which, in a default mode, is the current time associated with the image 1100 being presented contemporaneously with its capture. If the user wishes to engage with the image content, the user may tap (as signified by the dotted circle 400) on the image widget 236 with a digit 222.

Referring to FIG. 11B, in response to the user's tap, the image data presented in the image widget is paused, thereby causing the image widget 236 to present a still image 1106 that was presented at the time the user tapped the image widget 236. A pause/play indicator 1108 may be displayed to indicate that a stream of image data is paused. If the user wishes to engage the image data further, in implementations, the user may press and hold the image widget 236 with a digit 222 (as signified by the solid circle 412 beneath the digit). Referring to FIG. 11C, in response to the user's action, a set of image controls 1110 are invoked in the image widget 236. The set of image controls, in implementations, includes a zoom control 1112 to allow the user to enlarge or widen the field of the image data. The user may engage a still image, such as the image 1106, or enable the image data to play by using a play/pause toggle input 1114. The user may also use rewind 1116 or fast forward inputs 1118 to move back or advance within the image data. A power button 1120 also may be provided if the user wished to disable the capture of image data for the sake of privacy or for another reason.

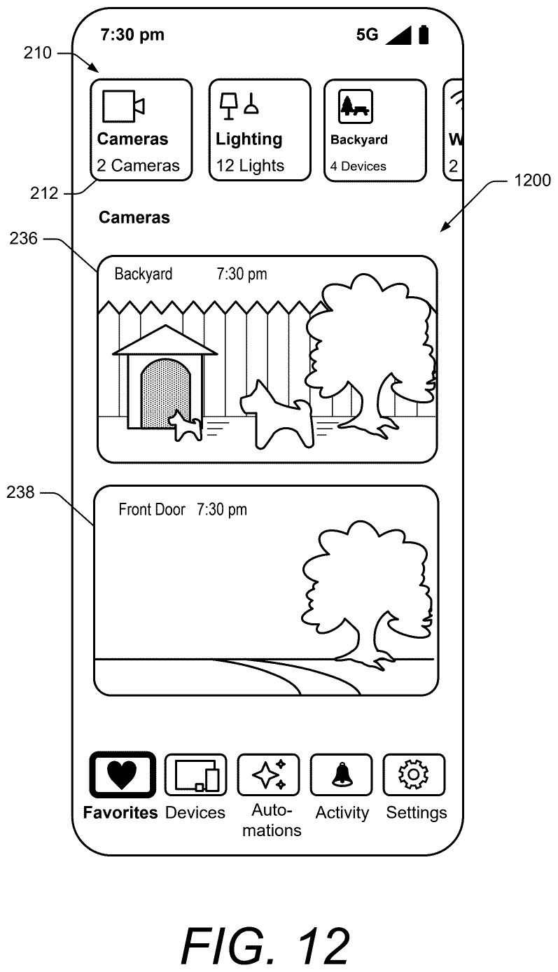

FIG. 12 illustrates an example cameras space to access image. Referring to FIG. 12, the image widgets 236 and 238 for the two cameras 122 and 150 (see FIG. 1) may be included in a cameras space 1200 accessible by selecting the camera tile 212 from the set of control tiles 210 previously described with reference to FIG. 2. As a result, image data from both cameras may be accessed and engaged, as described with reference to FIGS. 11A-11C, from a single screen. If additional image-capturing network-connected devices were included in the device management system, the user could scroll to additional camera widgets as the user was able to scroll through the favorites screen as also described with reference to FIG. 2. As also previously described, one or more image widgets from available cameras may be included on the favorites screen 200 and accessed as described with reference to FIGS. 11A-11C directly from the favorites screen 200.

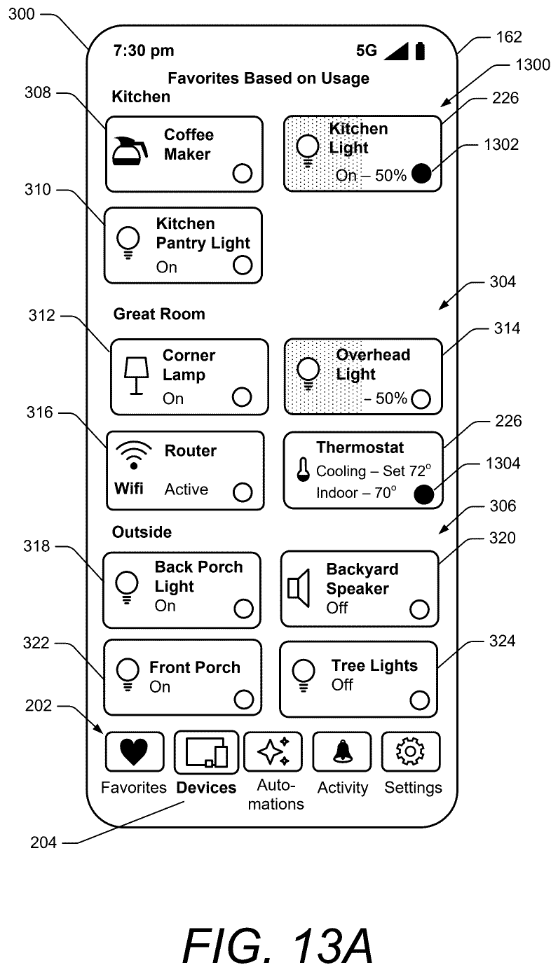

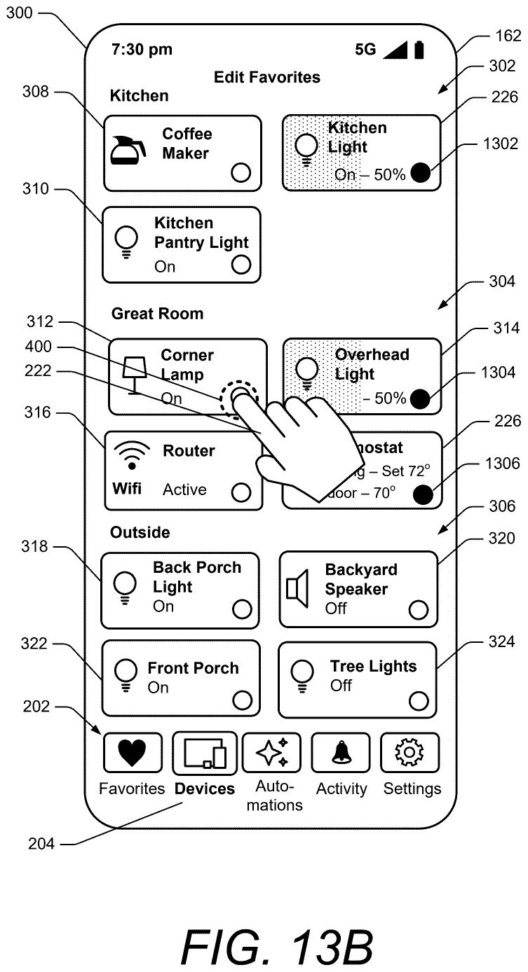

As previously described with reference to the favorites screen 200 of FIG. 2, a user can be afforded the ability to select what widgets may appear and/or in what order the widgets may be organized. FIGS. 13A and 13B illustrate example techniques for user-customization of the favorites screen 200. As illustrated in FIG. 13A, a set of suggested widgets 1300 are presented for the user's consideration for inclusion on the favorites screen 200. The set of suggested widgets 1300 may include a list of only the suggested widgets. Alternatively, the set of suggested widgets 1300 may include all the available widgets with, optionally, the suggested widgets flagged by markers 1302 and 1304. In the example of FIG. 13A, the widgets presented include the same set of widgets presented on the devices list of FIG. 3, with suggested widgets marked with the markers 1302 and 1304. Referring to FIG. 2, it will be appreciated that the marked widgets 226 and 228 were included as favorites on the favorites screen 200.

The device management system may suggest favorite widgets based on many different factors. To list a few examples, the device management system may suggest the newest devices to be included as favorites; the device management system may suggest devices that were favorited by other users; or, as shown in FIG. 13A, the suggested favorites may be based on usage, suggesting those devices that the user has used the most either through the client device 162 or through other interfaces.

The user may manually add or edit favorites by selecting checkboxes, such as those flagged with the markers 1302 and 1304 (FIG. 13A) to remove widgets from the favorites screen 200 or by flagging additional widgets to add them to the favorites screen 200. Referring to FIG. 13B, in addition to the previously flagged widgets 226 and 228, by tapping on selected widgets 312 and 314 with a digit 222 (as signified by the dotted circle 400), the user may add additional widgets to the favorites screen.

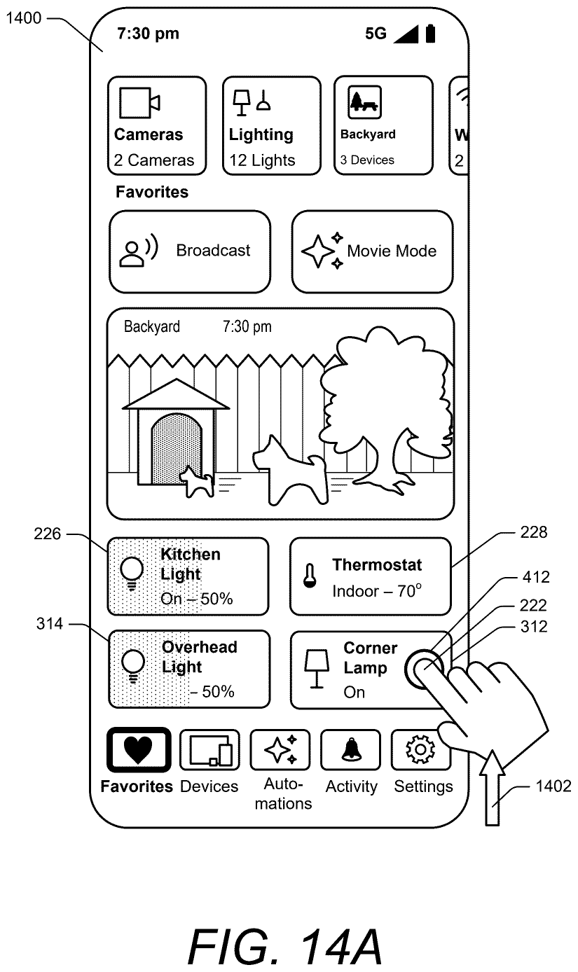

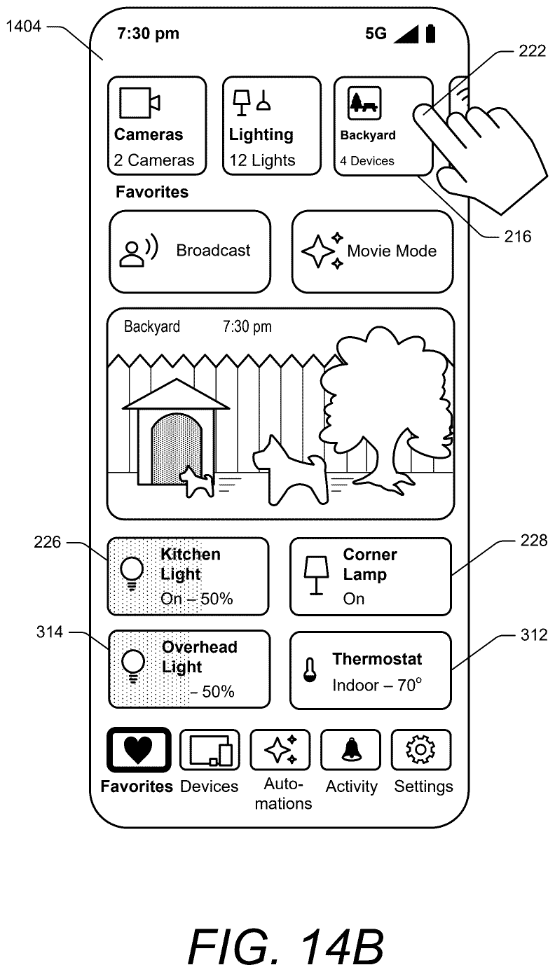

FIGS. 14A and 14B illustrate example techniques to modify placements of widgets on the favorites screen of FIG. 2. As illustrated in FIG. 14A, the newly-selected widgets of FIG. 13B (for sake of example only), including the corner lamp widget 312 and the overhead light widget 314, are added to a revised favorites screen 1400. If the user wishes to change the position of the widgets, the user can do so, for example, by dragging the widgets to new locations. For example, in FIG. 14A, by holding the digit 222 (as represented by the solid circle 412 under the digit) on a widget, such as the corner lamp widget 312, and dragging the corner lamp widget 312 in a direction 1402, the user can move the corner lamp widget 312 to a new location. Referring to FIG. 14B, a further updated favorites screen 1404 presents the corner lamp widget 312 at a location where the thermostat widget 228 previously resided, and the thermostat widget 228 automatically assumed the previous location of the corner lamp widget 312.

As previously described, in addition to creating and/or editing a favorites screen, a user can create, edit, and maintain additional spaces that may be accessed, for example, through the control tiles 210. For example, from FIG. 14B. using the digit 222, the user selects the backyard control tile 216 to access the space created for the backyard 108 of the home property 102 (see FIG. 1).

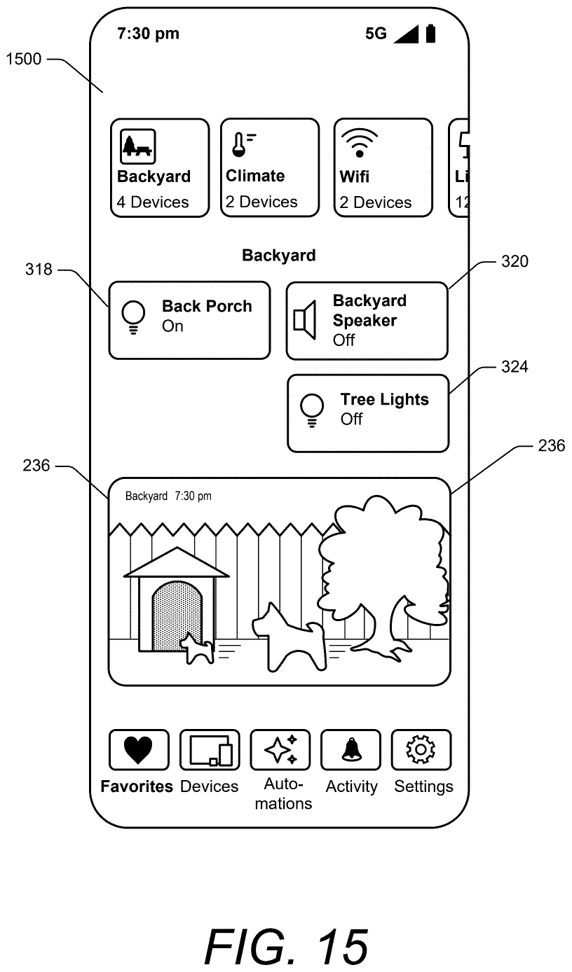

FIG. 15 illustrates an example customized space created by a user. As illustrated, the backyard space 1500 includes four widgets, the back porch light widget 318, the backyard speaker widget 320, the tree lights widget 324, and the backyard camera image widget 236. In this way, when the user wishes to monitor or control devices in the backyard, the selected network-connected devices are grouped in one space for easy access. Such techniques of the device management system facilitate control and management of network-connected devices in a network environment 100 (see FIG. 1).

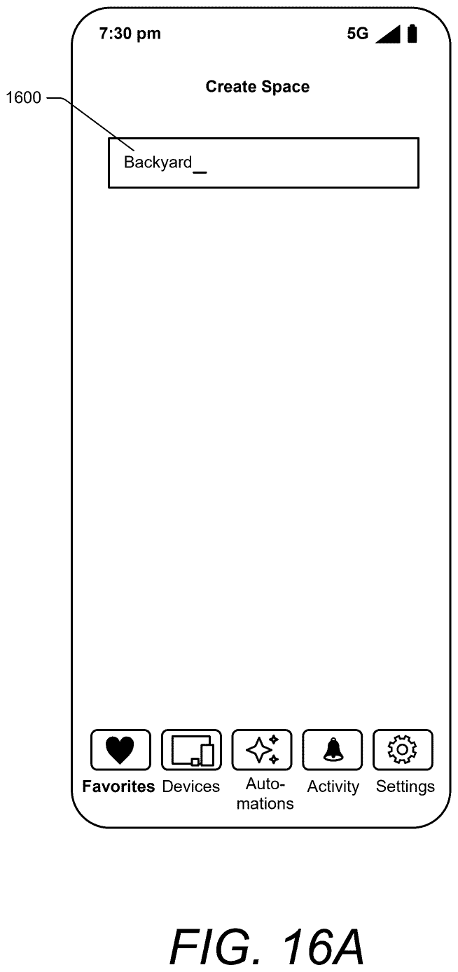

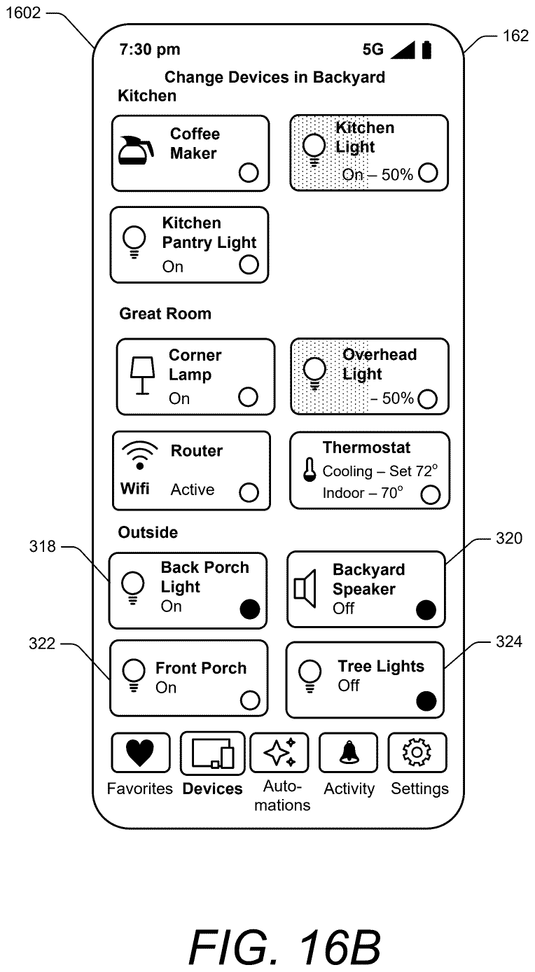

FIGS. 16A and 16B illustrate example techniques to create the customized space of FIG. 15. FIG. 16A illustrates how creation of the backyard space 1500 may have been initiated by editing a name 1600 of a new space. FIG. 16B illustrates the user selecting widgets from an add devices screen 1602 where the back porch light widget 318, the backyard speaker widget 320, and the tree lights widget 324 are selected; the backyard camera image widget 236 also is selected from another screen (not shown).

### Enhanced Image Interface

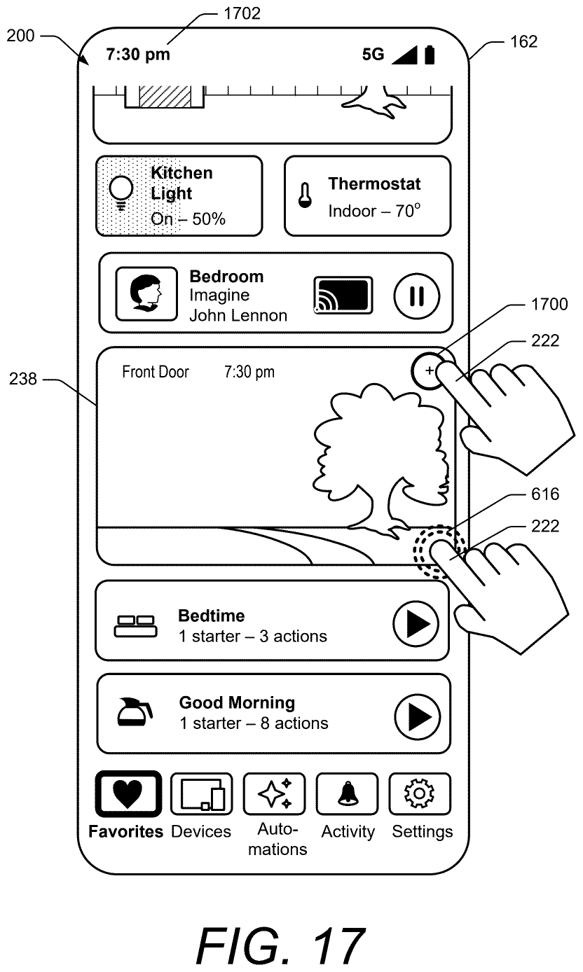

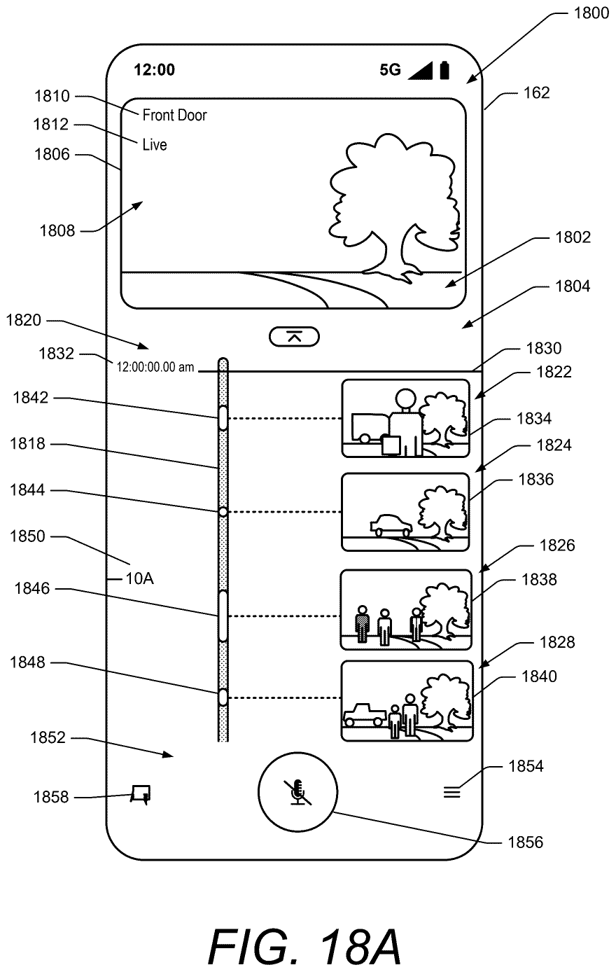

FIGS. 11A-11C and 12 show image widgets 236 and 238 that may be used to access image data from available cameras directly from a favorites page 200 (FIG. 2) or other spaces, such as the cameras space 1200 (FIG. 12) or a custom, backyard space 1500 (FIG. 15). Referring to FIG. 17, as previously described with reference to FIG. 11A, a user may engage the widgets 236 and 238 by tapping on the widgets 236 and 238 to pause a stream of image data or by holding a digit 222 on the widgets 236 and 238 to access image controls 1110.

In implementations, instead of using the image widgets 236 and 238, a user may be able to invoke an enhanced image interface. FIG. 17 illustrates an example technique to access an enhanced image interface (not shown in FIG. 17). As illustrated, the enhanced image interface may be accessed from the favorites screen 200 by repeatedly tapping (as represented by the concentric dotted circles 616) the image widget 238 with a digit 222 or by engaging an on-screen button 1700 with the digit 222.

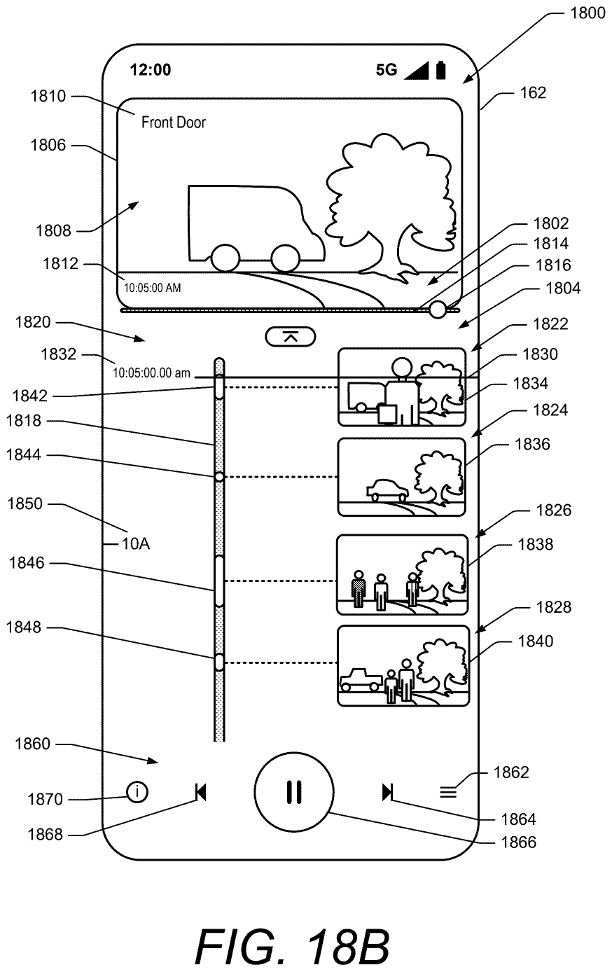

FIGS. 18A and 18B illustrate example implementations of an enhanced image interface 1800. As illustrated in FIG. 18A, an enhanced image interface 1800 includes a first region 1802 and a second region 1804. The first region 1802 includes an image window 1806 that is configured to display image data 1808, including an image or a series of images that comprise a video. The image data 1808 may be captured by a camera, such as camera 122 or 150 (see FIG. 1). In some implementations, the image window 1806 includes a location indicator 1810 (positioned anywhere within, for example, the first region 1802) to identify a source of the image data, such as the front door camera 122, and a time indicator 1812 (e.g., a live feed indicator) at which the displayed image was captured.

As illustrated in FIG. 18B, when the enhanced image interface 1800 displays image data 1808 from an earlier period, the first region 1802 may further include a horizontal timeline 1814 and a horizontal timeline indicator 1816. The horizontal timeline indicator 1816 may be transitioned across the horizontal timeline 1814 to advance or rewind the image data presented in the image window 1806 and/or, when image data for a particular event is played in the image window 1806, the horizontal timeline indicator 1816 represents a time position within the image data. The horizontal timeline indicator 1816 may be linked to a position relative to the horizontal timeline 1814 for an event for which the image data is currently presented in the image window 1806.

Turning back to FIG. 18A, the second region 1804 includes a vertical timeline 1818 that represents a time period in which multiple sets of image data have been captured. As further described below, implementations may include a dynamic timeline 1820 that, rather than being linearly scaled with the time period covered by the vertical timeline 1818, is scaled relative to events 1822, 1824, 1826, and 1828 captured during the time period. Each of the events 1822, 1824, 1826, and 1828 includes a set of image data of one or more images captured by a camera in response to some trigger, as further described below. A vertical timeline indicator 1830 is positioned on or adjacent to the vertical timeline 1818. The vertical timeline indicator 1830 is associated with a time indicator 1832 that represents a time at which the image data presented in the image window 1806 was captured.

By contrast with how the horizontal timeline indicator 1816 may be transitioned along the horizontal timeline 1814 or moves across the horizontal timeline 1814 to represent a time position within image data for a currently displayed event (see FIG. 18B), the vertical timeline 1818 may be transitioned relative to the vertical timeline indicator 1830 to advance or rewind image data within the image data for a currently displayed event and may be manipulated to switch to image data for other events along the vertical timeline 1818. In implementations, the vertical timeline 1818 is moved relative to the vertical timeline indicator 1830 to specify or represent a time position within the image data for the event displayed in the image window 1806. In implementations, the horizontal timeline 1814 and the horizontal timeline indicator 1816 appear in the first region 1802 when a user transitions the vertical timeline 1818 with respect to the vertical timeline indicator 1830.

Because the vertical timeline 1818 spans a time period in which many sets of image data are captured, such as events 1822, 1824, 1826, and 1828, manipulation of the vertical timeline 1818 may be regarded as providing a coarse or rapid scrubbing input to move quickly within and between sets of image data associated with the events 1822, 1824, 1826, or 1828. By contrast, as illustrated in FIG. 18B, because the horizontal timeline 1814 represents a timeline of the set of image data displayed in the image window 1806, manipulation of the horizontal timeline indicator 1816 may be regarded as a fine scrubbing input that provides fine or slower scrubbing through the set of image data displayed in the image window 1806. As further described below, in implementations, positions of the horizontal timeline indicator 1816 relative to the horizontal timeline 1814 and of the vertical timeline 1818 relative to the vertical timeline indicator 1830 are synchronized to enable the user to switch between the vertical timeline 1818 and the horizontal timeline indicator 1816 in controlling presentation of the image data.

For example, transitioning the horizontal timeline indicator 1816 relative to the horizontal timeline 1814 through a distance may result in the image data advancing or rewinding by a first displacement and at a first rate, while transitioning the vertical timeline 1818 relative to the vertical timeline indicator 1830 through a same distance may result in the image data advancing or rewinding by a second displacement and at a second rate. Generally, because the vertical timeline 1818 may be scaled to accommodate multiple events 1822, 1824, 1826, and 1828, potentially spanning multiple screens, moving the vertical timeline 1818 through the same distance will result in a second displacement and a second rate of movement of the image data that is much greater or faster, respectively, that the first displacement and the first rate of movement of the horizontal timeline indicator 1816 relative to the horizontal timeline 1814, as further illustrated below.

The vertical timeline 1818 also may be transitioned between the sets of image data associated with the events 1822, 1824, 1826, or 1828, and thus allows for scrubbing between the image data representing the events 1822, 1824, 1826, and/or 1828, as well as scrubbing within the individual sets of image data associated with the events 1822, 1824, 1826, and/or 1828. The vertical timeline 1818 may accommodate more events than may fit on a single screen of the client device 162. Thus, transitioning the vertical timeline 1818 may scroll forward or backward between screens of events.

In implementations, each of the events 1822, 1824, 1826, or 1828 is associated with a thumbnail image 1834, 1836, 1838, and 1840, respectively. The thumbnail images 1834, 1836, 1838, and 1840 may be selected or created from the set of image data associated with each of the events 1822, 1824, 1826, and 1838, respectively, as further described below. A start of an event may be identified by one or more sensors detecting at least one of motion, audio, or a trigger event (e.g., a doorbell button push). The event may continue either until the sensed data is no longer detected, for a fixed duration, for the interval during which sensed data is detected plus an additional trailing interval that may be set to capture any residual activity. Recognition of an event may be based on a threshold degree of movement so that, for example, trees moving in the wind or birds flying through a field of view may not signify occurrence of an event. The determination of a start or end of an event to be captured also may be based on other triggers, such as activation of an alarm, detection of audio over a threshold volume, a preprogrammed time during which image data is captured, manual activation of image capture, or other triggers.

A duration of each of the events 1822, 1824, 1826, and 1828 is represented by an event indicator 1842, 1844, 1846, and 1848 positioned on or adjacent to the vertical timeline 1818. In implementations, each of the event indicators 1842, 1844, 1846, or 1848 is a graphical object having a length in a dimension parallel to the vertical timeline 1818 that is representative of the duration of the respective event 1822, 1824, 1826, or 1828, respectively. In the example shown in the figures, the event indicators 1842, 1844, 1846, or 1848 are oval-shaped “pills,” where a length of each of the pills represents a duration of the respective event 1822, 1824, 1826, or 1828. Each of the event indicators 1842, 1844, 1846, or 1848 may be positioned on the vertical timeline 1818 relative to one or more time markers 1850 to provide an indication of when a respective event 1822, 1824, 1826, or 1828 occurred.

In implementations, as illustrated in FIG. 18A, the enhanced image interface 1800 may also include controls 1852. The controls 1852 can include a menu icon 1854 (e.g., for more actions, selecting the icon may open a side menu for a selection of options), a microphone icon 1856 (e.g., tapping the microphone icon may enable or disable voice output through a camera device via the client device 162), and a quick responses icon 1858 (e.g., selectable audio or visual responses). As illustrated in FIG. 18B, when the enhanced image interface 1800 displays image data 1808 from an earlier period, the enhanced image interface 1800 may further provide media controls 1860. The media controls 1860 can include a menu icon 1862 (e.g., menu icon 1854), a fast forward button 1864 (e.g., next event), a play/pause button 1866, a rewind button 1868 (e.g., previous event), and a more information button 1870.

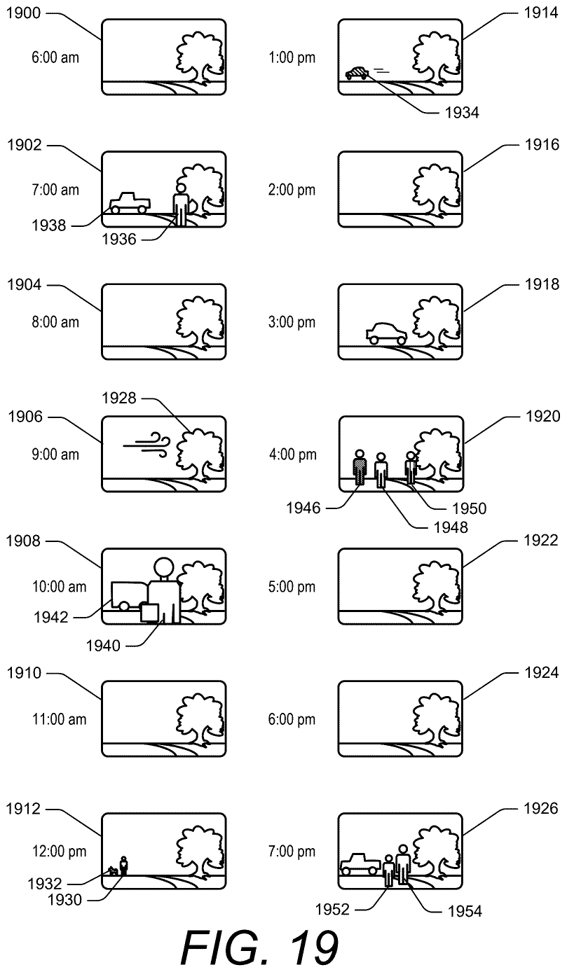

For the sake of example only and not by way of limitation, FIG. 19 illustrates image data (views 1900, 1902, 1904, 1906, 1908, 1910, 1912, 1914, 1916, 1918, 1920, 1922, 1924, and 1926) captured by the front camera 122 (FIG. 1). As illustrated, the views are captured hourly between 6:00 A.M. and 7:00 P.M. to demonstrate operation of the enhanced image interface 1800. For purposes of the example, it is assumed that events, such as events 1822, 1824, 1826, and 1828, are identified by motion detected in the field of view of the front camera 122. Thus, not all of the views result in the identification of an event.

The 6:00 A.M. view 1900 shows no moving objects. Thus, the 6:00 A.M. view is not regarded as an event and, thus, will not be represented on the vertical timeline 1818 (see FIG. 18). Similarly, the 8:00 A.M. view 1906, the 11:00 A.M. view 1910, the 2:00 P.M. view 1916, the 5:00 P.M. view 1922, and the 6:00 P.M. view 1924 also show no moving objects and will not be regarded as events to be included on the vertical timeline 1818.

The 9:00 A.M. view 1906 shows a tree 1928 moving in the wind. It is presumed, however, that the movement of the tree 1928 does not rise to the level of an event. Similarly, although the 12:00 P.M. view 1912 shows a distant pedestrian 1930 and a dog 1932, their passing also does not rise to the level of an event due to, for example, user-determined motion zones and/or machine-learned analysis of the image data. Also, the 1:00 P.M. view 1914 shows a passing vehicle 1934 but, as a result of its remoteness and/or its transitory passing, the passing vehicle is not classified as an event.

By contrast, the 7:00 A.M. view 1902 shows an individual 1936 and a nearby vehicle 1938, motion of at least one of which indicates occurrence of an event. The 10:00 A.M. view 1908 shows a delivery person 1940 and their truck 1942, motion, importance (e.g., machine-learned significance rating), and/or proximity which indicates occurrence of an event. The 3:00 P.M. view 1918 shows a vehicle 1944 parked directly in front of the home, indicating occurrence of an event. The 4:00 P.M. view 1920 shows children 1946, 1948, and 1950 playing, which constitutes an event. Finally, the 7:00 P.M. view 1926 shows two individuals 1952 and 1954 approaching and a nearby vehicle 1956, also constituting an event. It may be considered that the 7:00 A.M. view 1902 and the 7:00 P.M. view 1926 show residents of the home leaving and returning to the home; however, unless monitoring systems are configured to disregard known persons, the departures and arrivals will be classified as events. Thus, five events are identified in the 7:00 A.M. view 1902, the 10:00 A.M. view 1908, the 3:00 P.M. view 1918, the 4:00 P.M. view 1920, and the 7:00 P.M. view 1926. Image data from the other views may not be captured and/or retained and may not be of interest to a user of the device management system (FIG. 1). In implementations, the enhanced image interface 1800 (FIG. 18) may exclude the views that are not classified as events, as further described below.

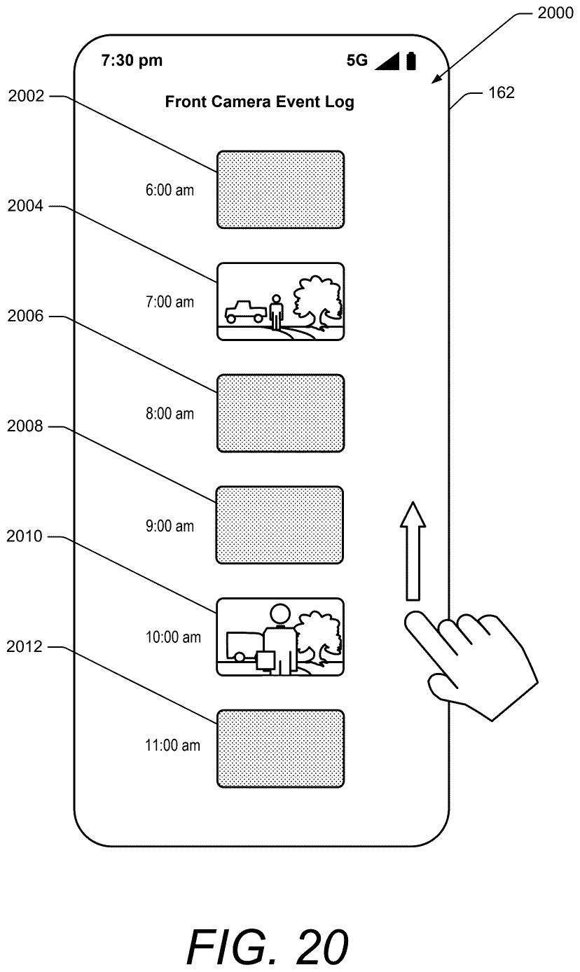

FIG. 20 illustrates an example front camera event log accessible by a user of the device management system via the client device 162. As previously described, most of the views of the front camera 122 as shown in FIG. 19 were not classified as events and, thus, image data may not be captured, retained, and/or presented by the front camera 122 and/or the device management system. As a result, for log entries 2002, 2004, 2006, 2008, 2010, and 2012 presented on a screen of the front camera event log 2000, only log entries 2004 and 2010 (corresponding to views 1902 and 1908 of FIG. 19) present events for the user's consideration. Remaining entries 2002, 2006, 2008, 2012, and other entries on other screens (not shown in FIG. 20) are empty entries past which or through which a user might scroll without being presented with any information of potential interest. As described below, the enhanced image interface 1800 omits these entries and selectively condenses the vertical timeline 1818 to expedite a user's ability to access recorded events.

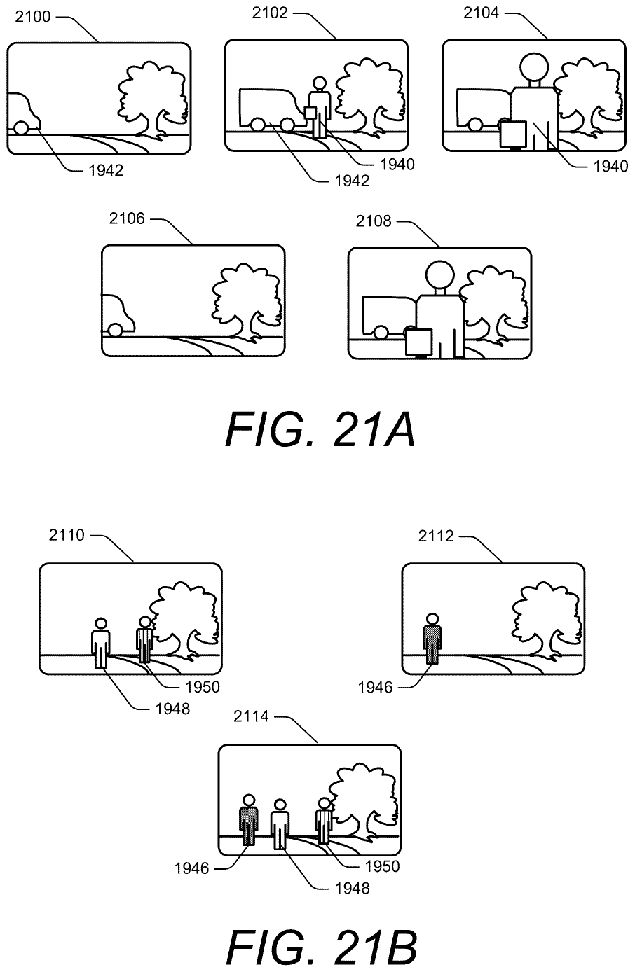

In addition to adjusting the vertical timeline 1818 (see FIG. 18) to expedite the user's ability to access recording events, image data may be processed so that the thumbnail images 1834, 1836, 1838, and 1840 provide meaningful representations of an associated event. FIGS. 21A and 21B illustrate example techniques to present representative thumbnail images of one or more events. As illustrated in FIG. 21A, three images 2100, 2102, and 2104 from the 10:00 A.M. event, as depicted in view 1908 (see FIG. 19), show portions of the event. The first image 2100 shows an arrival of the delivery truck 1942. The second image 2102 shows the delivery person 1940 beginning to approach the front camera 122 of the home property 102 (see FIG. 1). The third image 2104 shows the delivery person 1940 at the front door 110 of the home property 102.

From the images 2100, 2102, and 2104, or other images, the first image 2100 may be selected as a thumbnail image 2106. The first image 2100 is captured proximate in time to occurrence of the event and, by representing a first aspect of the event, may present a suitable representative image to use as a thumbnail image 2106. Alternatively, the third image 2104, representing the instance of greatest proximity to the home property 102 and, relative to the front camera 122, the greatest degree of motion, the third image 2104 may be the most representative image captured. Thus, the third image 2104 may also present a suitable representative image to be used as thumbnail image 2108.

Referring to FIG. 21B, two images 2110 and 2112 from the 4:00 P.M. event depicted in view 1920. The first image 2110 shows the children 1948 and 1950 and the second image 2112 shows the child 1946. However, it is possible that not all of the children 1946, 1948, and 1950 appear in the same image. Accordingly, a thumbnail image 2114 may be a composite image generated from the images 2110 and 2112 (and/or other images) to present a representative image that shows all three children 1946, 1948, and 1950. In implementations, different methods of presenting a thumbnail image (i.e., selecting a first image proximate to the event or a most representative image as shown in FIG. 21A or preparing a composite image as shown in FIG. 21B) may all be used in selecting thumbnail images for use in the enhanced image interface. In the enhanced image interface 1800, the thumbnail image 2108 is used for the 10:00 A.M. event and the thumbnail image 2114 is used for the 4:00 P.M. event.

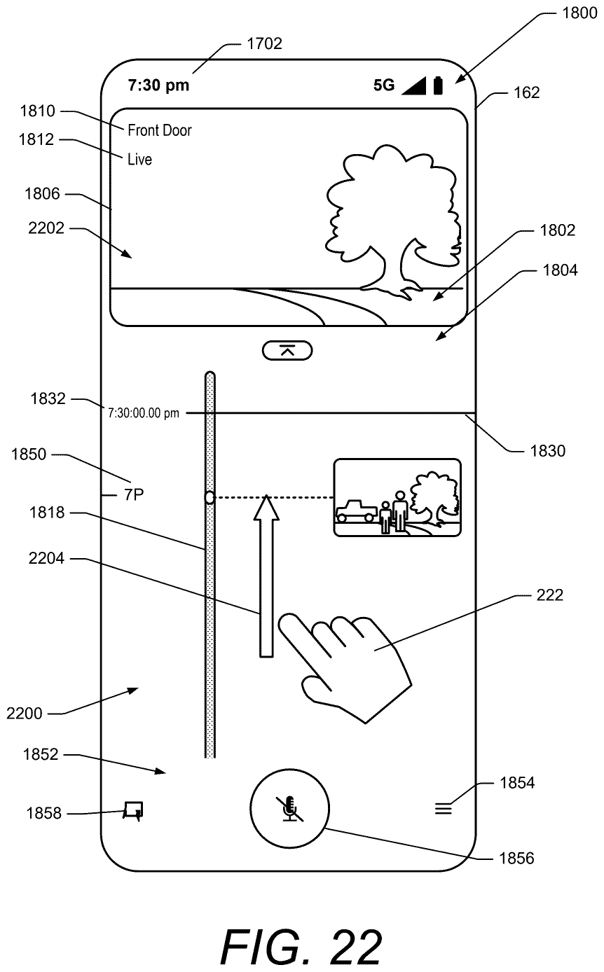

Referring to FIG. 22, when a user engages the image widget 238 as shown in FIG. 17, the enhanced image interface 1800 may be presented starting with a current time (e.g., live feed), as a default (see FIG. 18A). As shown in FIG. 17, the user engages the image widget 238 to invoke the enhanced image interface 1800 at a time 1702, 7:30 P.M. As illustrated in FIG. 22, an initial screen 2200 of the enhanced image interface 1800 is presented with the current time—as indicated by the time indicator 1832 reading 7:30 P.M.—and showing the image data 2202 in the image window 1806. The vertical timeline 1818 is positioned relative to the vertical time indicator 1830 where the time is the current time 7:30 P.M. If the user wishes to view events earlier in the day, the user can scroll on the initial screen 2200 by engaging the vertical timeline 1818 with the digit 222 to move the vertical timeline 1818 in a large, upward vertical displacement 2204 to access earlier events.

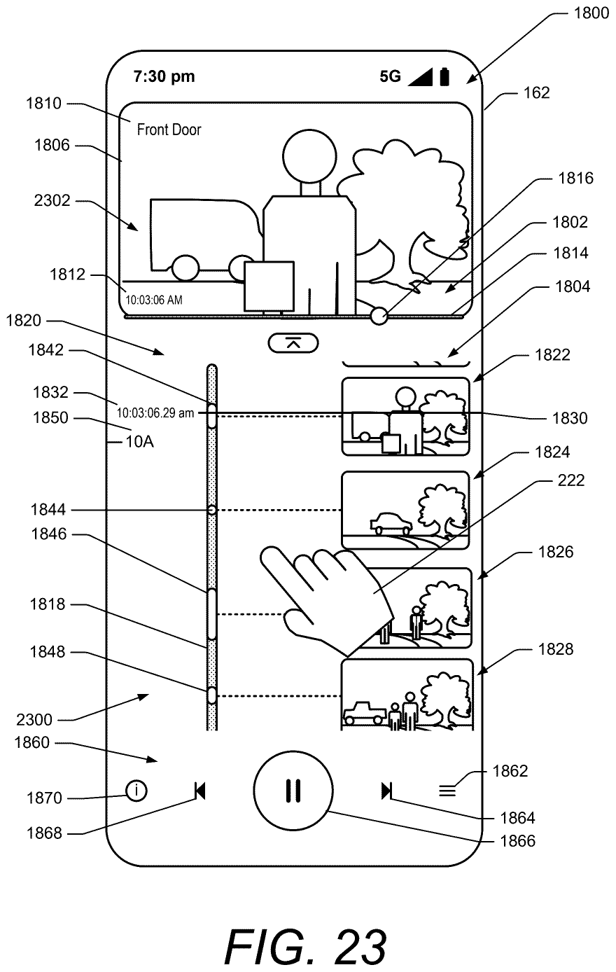

FIG. 23 illustrates an example of the enhanced image interface 1800 after the user has transitioned the vertical timeline 1818 to view image data from the event 1822 in the image window 1806. For example, the user has transitioned (with respect to FIG. 22) the vertical timeline 1818 so that the vertical timeline indicator 1830 is positioned at a point within the event indicator 1842 for the event 1822, which is at a point more than halfway along the time indicator 1832. As the time indicator 1832 shows, the time is 10:03:06.29 A.M. Accordingly, for example, instead of showing in the image window 1806 the image data from the start of the event as shown in the image 2100 (FIG. 21A), the image window 1806 shows image data 2300 at the time 10:30:06.29 A.M.

In implementations, the horizontal timeline 1814 and horizontal timeline indicator 1816 are operationally coupled with the vertical timeline 1818 and the vertical timeline indicator 1830. Because the user, using the digit 222, has transitioned the vertical timeline 1818 to a position more than halfway through the event indicator 1842 for the event 1822, the horizontal timeline indicator 1816 is correspondingly advanced to an equivalent position relative to the horizontal timeline 1814. Thus, the fast or coarse scrubbing between and through the events 1822, 1824, 1826, and 1828 made possible by manipulation of the vertical timeline 1818 relative to the vertical timeline indicator 1830 is synchronized with the capacity to perform fine or slow scrubbing using the horizontal timeline 1814 and horizontal timeline indicator 1816 that shows a position within image data just for the event 1822. Thus, a user can switch back and forth between manipulating the video data shown in the image window 1806 by using the vertical timeline 1818 and the horizontal timeline indicator 1816.

It should be appreciated that the dynamic timeline 1820, as evidenced in the vertical timeline 1818, may not linearly distribute the events 1822, 1824, 1826, and 1828. As described with reference to the front camera event log 2000 of FIG. 20, if a vertical timeline allocates space equally to all times, whether there are any events associated with those times or not, a user may have to perform an appreciable amount of paging or scrolling to view the image data for various events. By contrast, the dynamic timeline 1820, in effect, can collapse the vertical timeline 1818 to provide sufficient space for the thumbnail images (e.g., the thumbnail images 1834, 1836, 1838, and 1840) for each of the events 1822, 1824, 1826, and 1828, respectively.

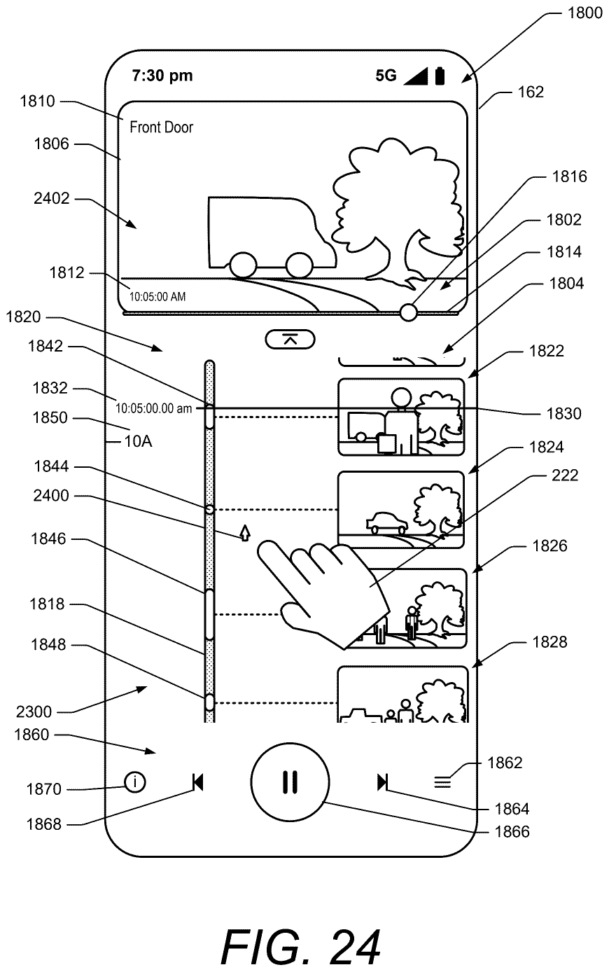

Referring to FIG. 24, by transitioning the vertical timeline 1818 to move an additional, small upward displacement 2400 within the event indicator 1842 for the event 1822, the user may move forward in the image data displayed in the image window 1806. In this example, the user has transitioned the vertical timeline 1818 to move closer to an end of the event 1822 as indicated by the time indicator 1832 reading 10:05:00.00 A.M. and the time indicator 1812 displayed in the image window 1806 reading 10:05:00 A.M. Because the horizontal time indicator 1816 is synchronized to the vertical timeline 1818, the horizontal timeline indicator 1816 moves to an end of the horizontal timeline 1814 corresponding to an end of the image data for the event 1822.

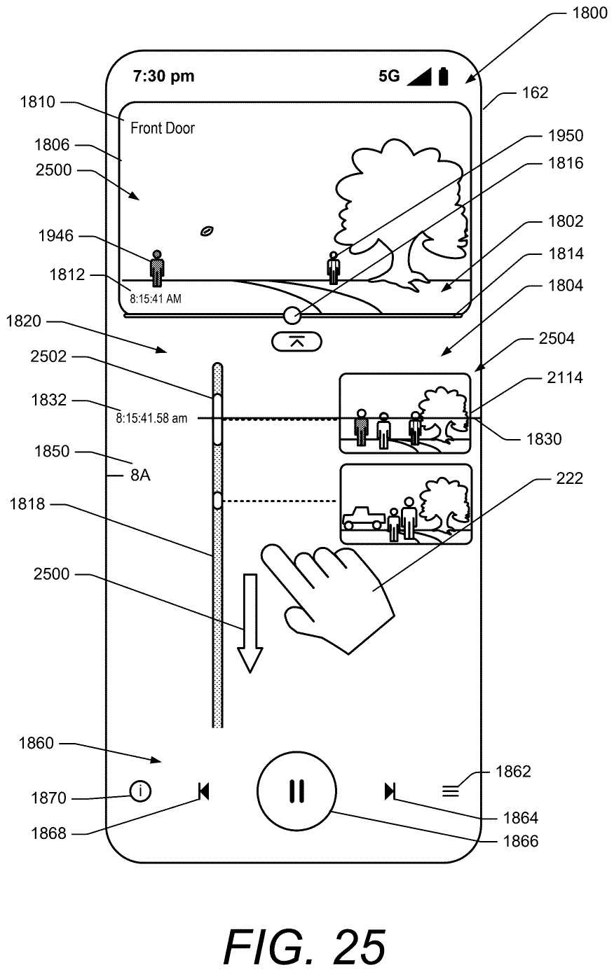

By contrast, referring to FIG. 25, by transitioning the vertical timeline 1818 to move through a larger, downward displacement 2500, the vertical time indicator 1830 is moved within an event indicator 2502 for an event 2504, at an earlier time, showing children playing, as indicated in the composite thumbnail image 2114. (The image window 1806 shows children playing; the image data for the event 2504 did not capture all three children at the same time, thus the creation of the composite thumbnail image 2114.) Specifically, the vertical time indicator 1830 is positioned approximately in a middle of the event indicator 2502. Accordingly, the horizontal timeline indicator 1816 is positioned approximately halfway across the horizontal timeline 1814 because a position of the horizontal timeline 1814 relative to the horizontal timeline indicator 1816 is correlated with the position of the vertical timeline indicator 1830 relative to the event indicator 2502 and, thus, the image data of the event 2504.

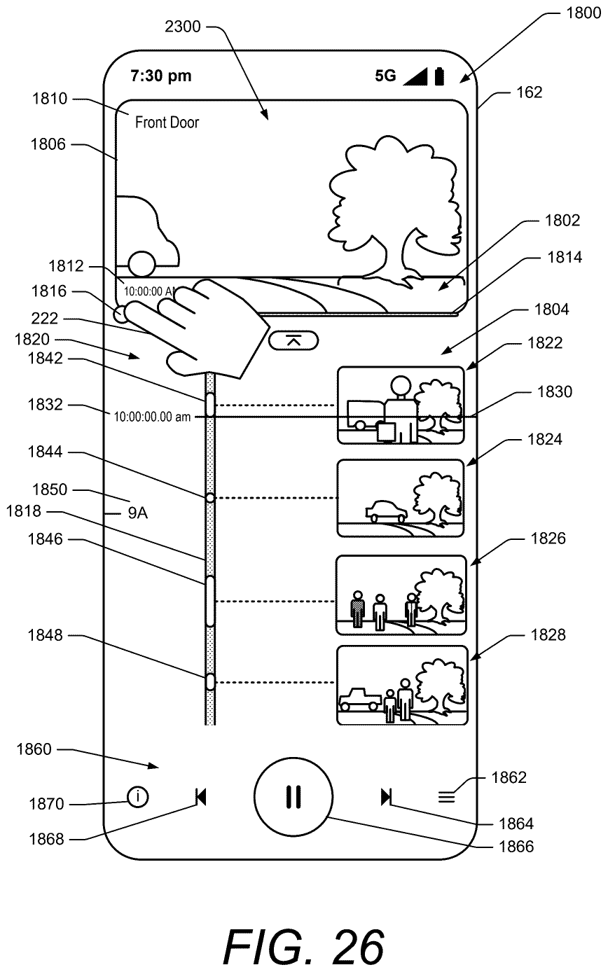

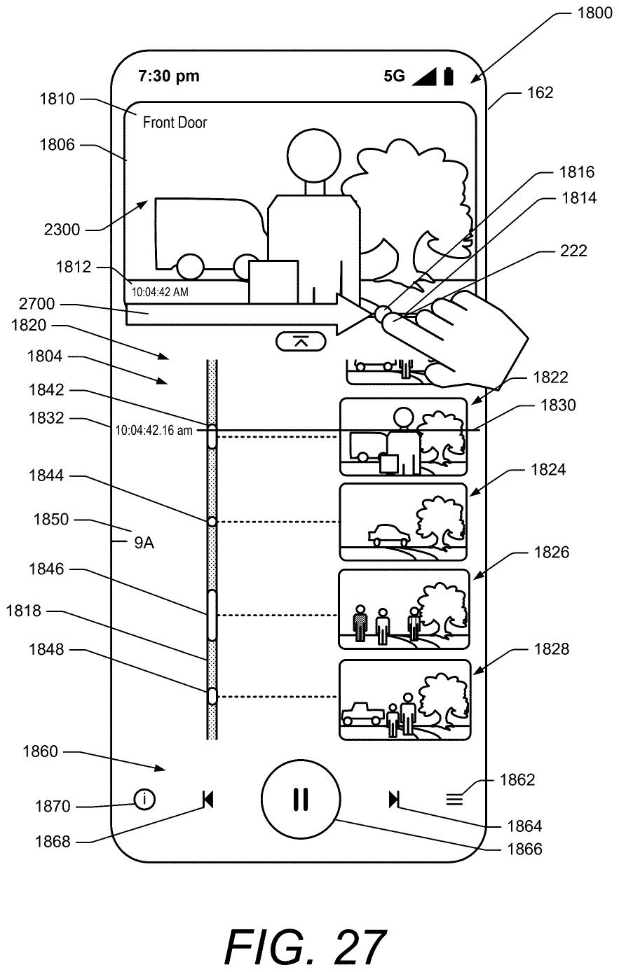

Referring again to FIG. 23, instead of the user utilizing digit 222 to transition the vertical timeline 1818, the user transitions the horizontal timeline indicator 1816, as illustrated in FIG. 26, to a start of an event 1822 and, thus, alters the image data presented in the image window 1806. Referring to FIG. 27, by advancing the horizontal timeline indicator 1816 via a large, horizontal displacement 2700, the horizontal timeline indicator 1816 may be advanced roughly three quarters of the way across the horizontal timeline 1814, similar to a horizontal displacement of the horizontal timeline indicator 1816 caused by the displacement 2400 as illustrated in FIG. 24. By comparing the size of the displacement 2400 of FIG. 24 used to move the vertical timeline 1818 between the two points within the event 1822 and the displacement 2700 of FIG. 27 used to move the horizontal timeline indicator 1816 between the same two points within the event 1822, the displacement 2700 of FIG. 27 is much greater. Thus, by requiring much greater displacement to advance between points within an event, manipulation of the horizontal timeline indicator 1816 enables much finer scrubbing through image data while manipulation of the vertical timeline 1818 enables much faster, coarse scrubbing through image data.

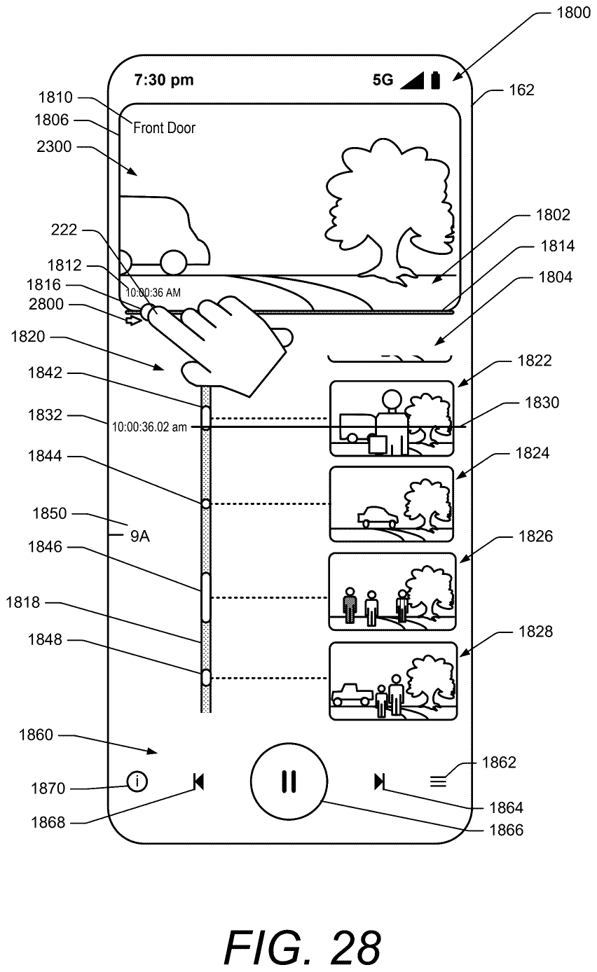

By way of further illustration, FIG. 28 shows the user advancing the horizontal timeline indicator 1816 by a displacement 2800 of a similar magnitude as the displacement 2400 (see FIG. 24) that the user applied to the vertical timeline 1818 to advance the image data for the event 1822. Instead of scrubbing quickly through the image data 1808 presented in the image window 1806 between FIGS. 23 and 24, which resulted in the time indicator 1832 showing a relatively larger time displacement, the fine scrubbing provided by transitioning the horizontal timeline indicator 1816 only slightly advances the image data 1808 between FIGS. 26 and 28.

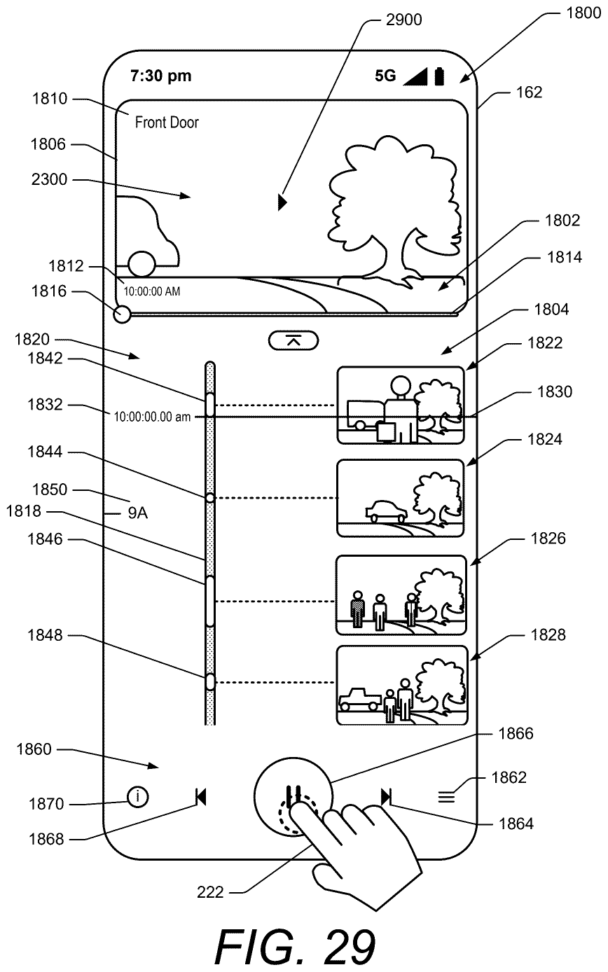

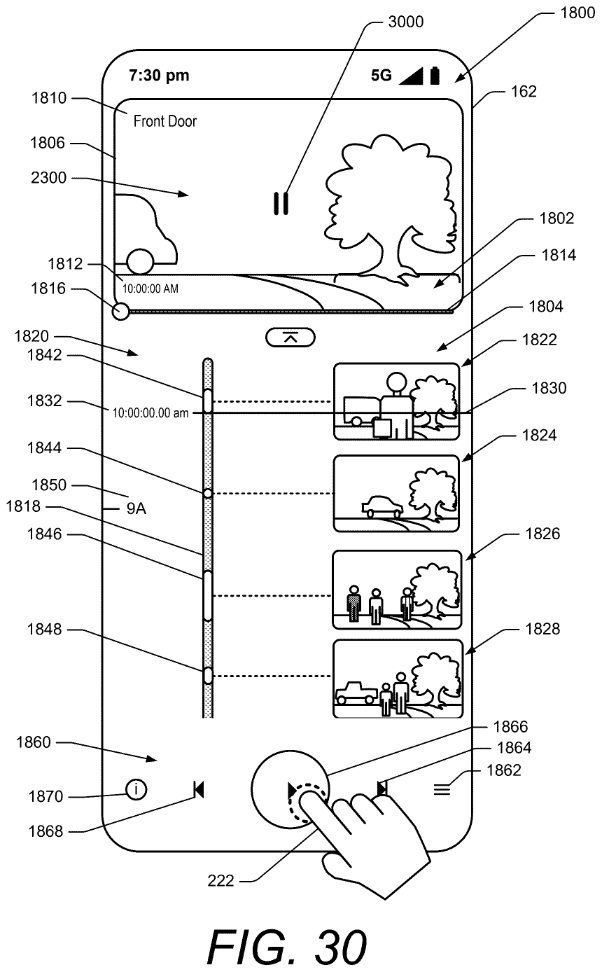

Instead of transitioning the horizontal timeline 1816 or the vertical timeline 1818 to scrub through image data, a user may use the media playback controls 1860 to control playback of a set of image data. For example, referring to FIG. 29, with the video timeline indicator 1830 positioned at a start of the image data for the event 1822, the user engages the play/pause button 1866 to play the video presented by the image data. As a result, the image window 1806 presents a play indicator 2900, temporarily, indicating that the video is playing. Referring to FIG. 30, the user, via digit 222, engages the play/pause button 1866 to pause the video. As a result, the image window 1806 presents a pause indicator 3000, temporarily, indicating that the video is paused.

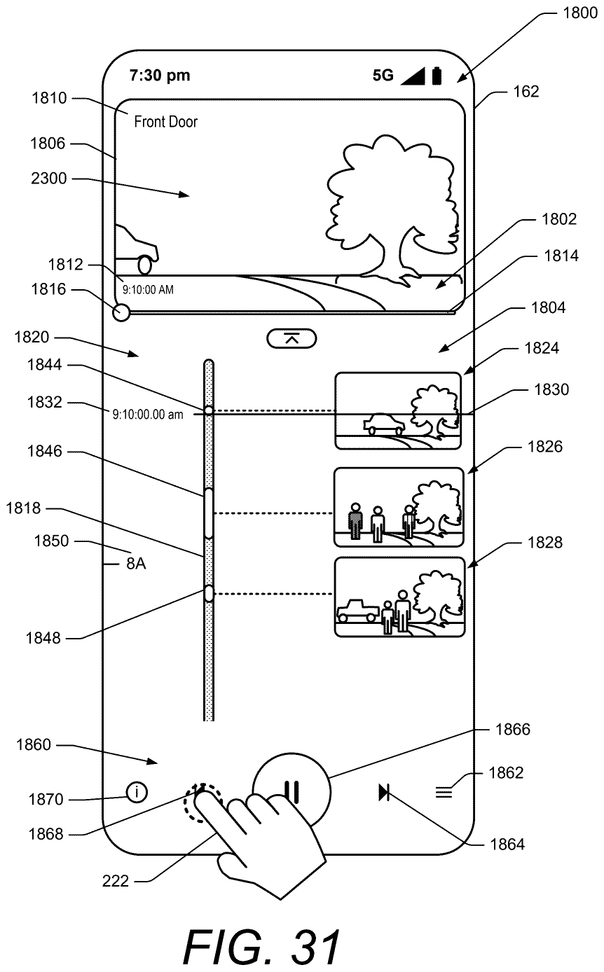

Referring to FIG. 31, the user may also use the rewind button 1868 to jump to a previous event or the fast forward button 1864 to jump to a next event. As illustrated, the user, via digit 222, selects the rewind button 1868 causing the vertical timeline 1818 to transition to a previous event and image data in the image window 1806 to be altered.

In additional implementations, the image window 1806 may present an icon representing a type of event recorded. For example, if the image data contains a human, the image window 1806 may display a human icon. In further implementations, the second region 1804 includes a date indicator.

### Script Editor to Create Automations

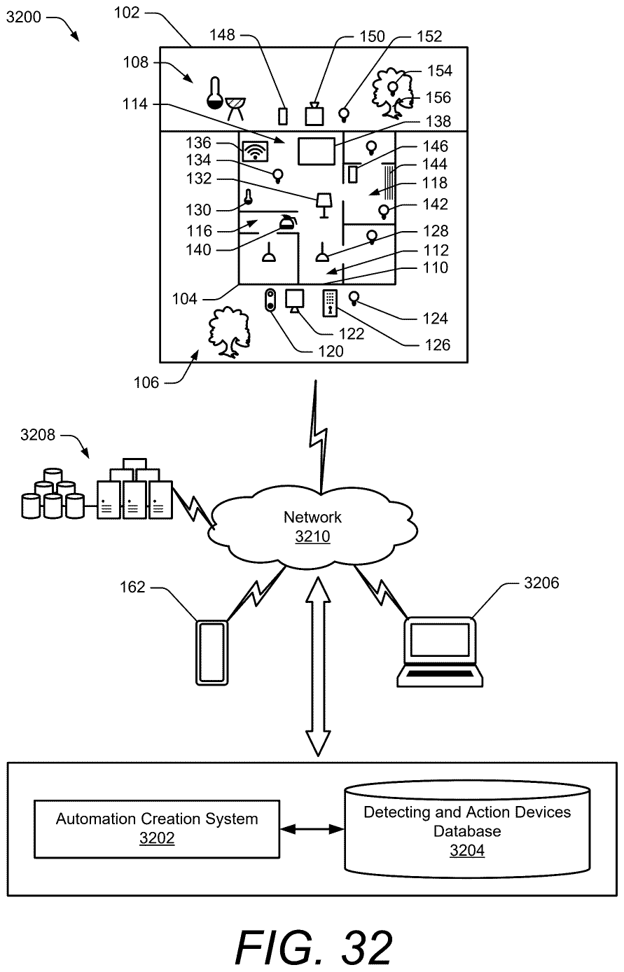

FIG. 32 illustrates example components and features of the device management system 3200, including an automation creation system 3202. As illustrated, the plurality of network-connected devices 120, 122, 124, 126, 128, 130, 132, 134, 136, 138, 140, 142, 144, 146, 148, 150, 152, and 154 (hereafter collectively referenced as “the network-connected devices”), which include detecting and action devices, may be operatively coupled to the client device 162, a computer 3206, and/or a remote computing system 3208 via a network 3210. The device management system 3200 may, among other abilities, enable of a subset of the network-connected devices that perform actions, which will be termed “action devices,” and/or to detect data from another subset of the devices, which will be termed “detecting devices.” (As described below, some of the network-connected devices may be action devices and detecting devices.) To facilitate creation of automations that enable automated or collective operation of the network-connected devices, the device management system includes the automation creation system 3202. The automation creation system 3202 works with a detecting and action devices database 3204 available within the device management system 3200. In the foregoing example, all of the devices, triggers, actions, statuses, and other options presented and that populate menus described below are drawn from the detecting and action devices database 3204. In implementations, the detecting and action devices database 3204 is automatically populated when each of the network-connected devices is added to the device management system 3200.

In implementations, the automation creation system 3202 provides an assistive interface accessible via the client device 162 or a computer 3206, such as a laptop computer, tablet computer, or desktop computer, that receives automation routines from users to facilitate or automate operation of one or more of the network-connected devices such as the bedtime automation widget 232 and the good morning automation widget 234 described with reference to FIGS. 2 and 10A-10C. In aspects, the interface of the automation creation system 3202 may be accessible by a user selecting the automations tab 208 (see FIG. 2). In implementations, at least portions of the device management system, including the automation creation system 3202 and/or the detecting and action devices database 3204, are maintained within the remote computing system 3208 (e.g., server system 166).

In implementations, the automation creation system 3202 enables creation of automation routines that, in response to one or more of the detecting devices detecting one or more triggers, causes one or more of the action devices to perform one or more actions and/or detecting devices to activate. In additional implementations, the automation routines, in response to one or more of the detecting devices detecting one or more triggers, causes one or more of the action devices to perform one or more actions and/or detecting devices to activate when one or more conditions are satisfied.

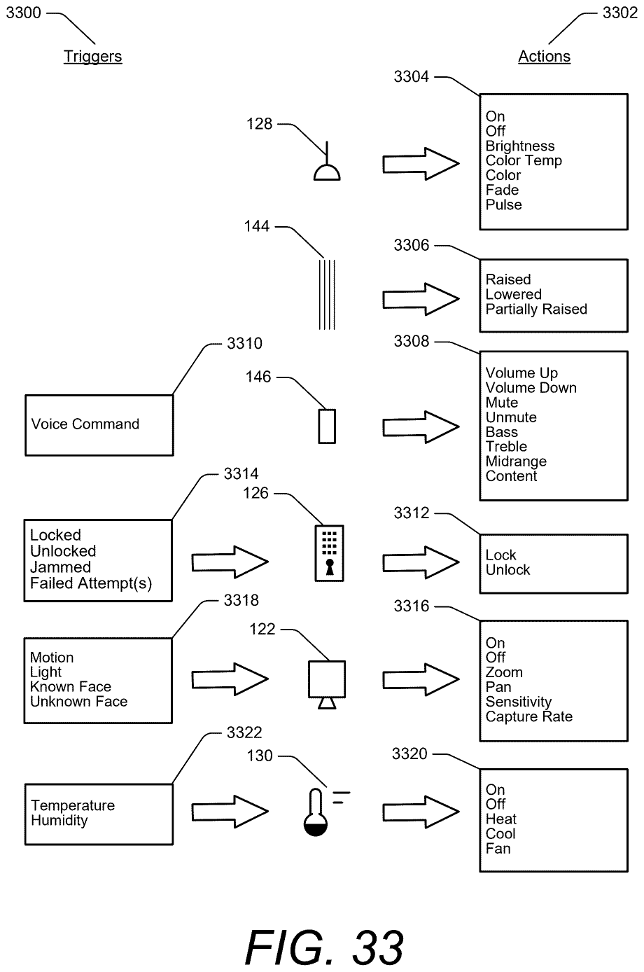

FIG. 33, provided by way of example, illustrates a schematic diagram of example devices, as well as actions that each device is configured to perform and/or triggers that each device is configured to detect. As illustrated, FIG. 33 lists some of the devices in the home property 102, including the entryway light 128, the automated blind 144, the smart speaker 146, the lock 126, the camera 122, and the thermostat 130 (see FIGS. 1 and 32) that are configured to detect one or more triggers 3300 and/or to perform one or more actions 3302. The entryway light 128 is an action device that is configured to perform a set of actions 3304 including turning off, turning off, and operating according to modes including brightness, color temperature, color, fading, or pulsing. The automated blind 144 is only an action device that is configured to perform a set of actions 3306 including raising, lowering, and partial raising.

The smart speaker 146 is both an action device and a detecting device. The smart speaker 146 is configured to perform a set of actions 3308 including volume up, volume down, mute, unmute, and operating in modes including a bass level, a treble level, and a midrange level as well as playing selected content. The smart speaker 146 is also a detecting device that is configured to respond to a set of triggers 3310 based on voice commands. As further described below, in addition to responding to a specified trigger or performing a type of action, parameters may be set to specify, for example, a trigger being set to a particular voice command and an action including an extent to which volume is turned up.

The lock 126 is both an action device and a detecting device. The lock 126 is configured to perform a set of actions 3312 including locking or unlocking. The lock 126 is also a detecting device that is configured to respond to a set of triggers 3314 including whether the lock 126 is locked, unlocked, jammed, or has received one or more failed locking or unlocking attempts. The camera 122 is both an action device and a detecting device. The camera 122 is configured to perform a set of actions 3316 including turning on, turning off, zooming, and panning, or operating according to modes including sensitivity and capture rate. The camera 122 is also a detecting device that is configured to respond to a set of triggers 3318 including motion, light, presence of a known face, and presence of an unknown face. The thermostat 130 is also both an action device and a detecting device. The thermostat 130 is configured to perform a set of actions 3320 including turning on, turning off, heating, cooling, and running a fan. The thermostat 130 is also a detecting device configured to respond to a set of triggers 3322 including temperature and humidity.

The sets of actions that the action devices are configured to perform and the sets of triggers to which the detecting devices are configured to respond provide a basis for the creation of automation routines using the automation creation interface presented by the automation creation system 3202. As described below, the automation creation interface presents an assistive interface that lists available devices that respond to triggers and lists the triggers to which the available devices are configured to respond and lists available devices that perform actions and lists the actions that the available devices are configured to perform. Thus, by choosing from lists of triggers and actions from the automation creation interface, a user may create automation routines without having to memorize or look up what devices are available, the actions that each of the devices is configured to perform, and/or the triggers to which each of the devices is configured to respond.

For the sake of illustration, using the automation creation system 3202, the user can create an automation routine that turns on the entryway light 128 when the lock 126 at the front door 110 of the home property 102 is unlocked. Thus, when an individual unlocks the lock 126, the entryway light 128 comes on to welcome the individual, which may be convenient to light the individual's way without having to actively turn on the entryway light 128.

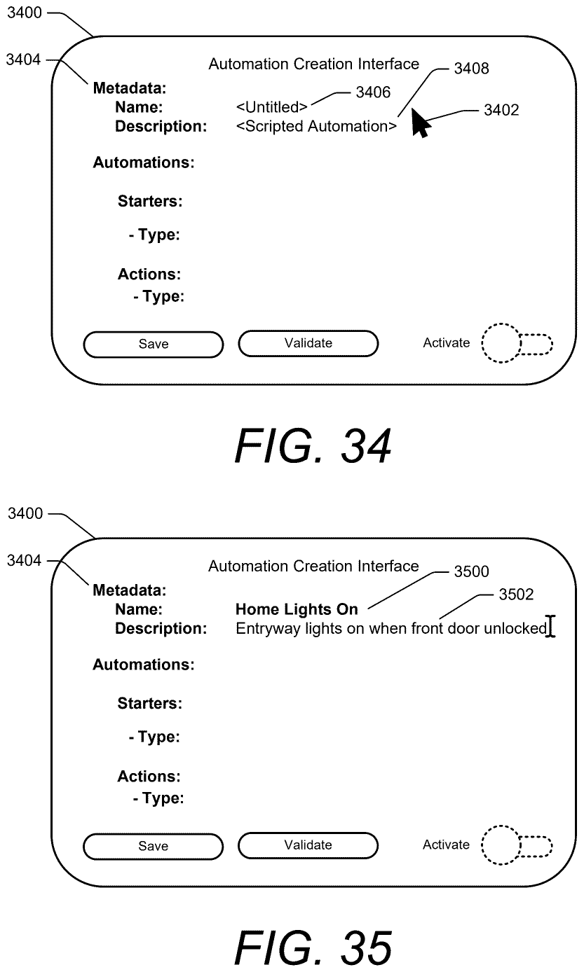

FIG. 34 illustrates an example automation creation interface screen 3400 presented by the automation creation system 3202 (see FIG. 32) with which a user (not shown) may interact via a computing device such as the client device 162 or a computer 3206. In the examples described with reference to FIGS. 34-49 and 52-54, the computer 3206 is used, thus the user invokes a cursor 3402 to engage input options on the automation creation interface screen 3400 and uses a keyboard (not shown in FIGS. 34-49 and 52-54) to enter parameters. However, the automation creation interface screen 3400 also may be presented on the client device 162 or another device with a touchscreen interface that the user may engage with a digit and use an on-screen keyboard to enter parameters.

To initiate creation of an automation routine via the automation creation interface screen 3400, the user may manipulate the cursor 3402 to engage a metadata input 3404 to engage a name input 3406 and a description input 3408. In implementations, use of the description input 3408 may be optional. the description (which may or may not be optional). Referring to FIG. 35, after selecting the respective inputs 3406 and 3408, the user employs an input device to specify a name 3500 for the automation routine, “Home Lights On,” and provides a description 3502 for the automation routine, “Entryway lights on when the front door is unlocked.”

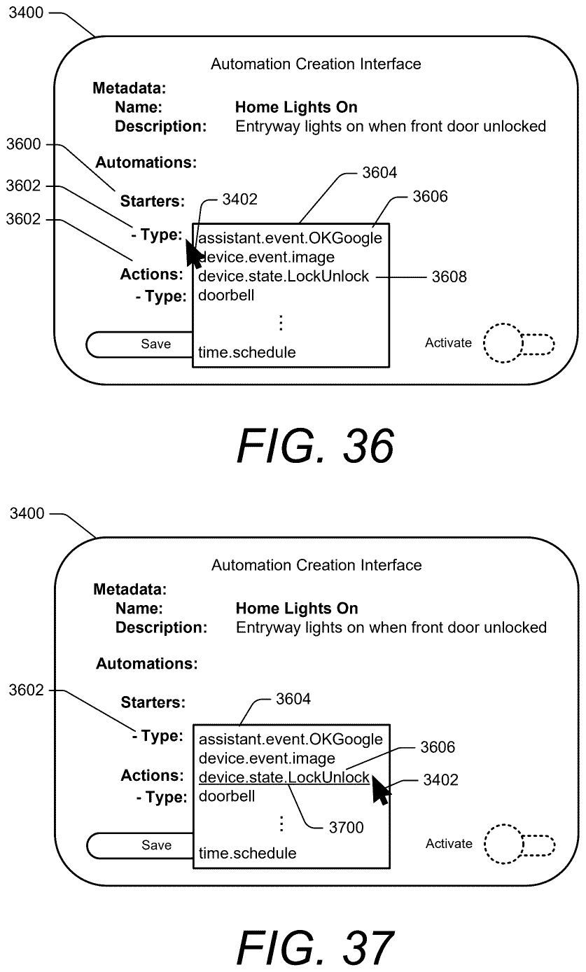

FIG. 36 illustrates a user engaging a starter input 3600 of the automation creation interface screen 3400 with the cursor 3402. The starter input 3600 enables a user to specify one or more triggers that will initiate the automation routine. In implementations, selecting a type input 3602 with the cursor 3402 invokes a starter menu 3604 from which the user may choose a selected trigger. The starter menu 3604, for example lists an “assistant.event.OKGoogle” trigger 3606 that will select a voice command as the trigger. Among other triggers listed in the starter menu 3604, a “device.state.Lock.Unlock” trigger 3608 selects a state of the lock 126 (see FIG. 33) as the trigger to initiate the automation routine. If many triggers are listed in the starter menu 3604 such that the starter menu 3604 cannot present all available triggers, the user may use the cursor 3402 or another input to scroll through the starter menu 3604 to access all available triggers listed in the starter menu 3604.

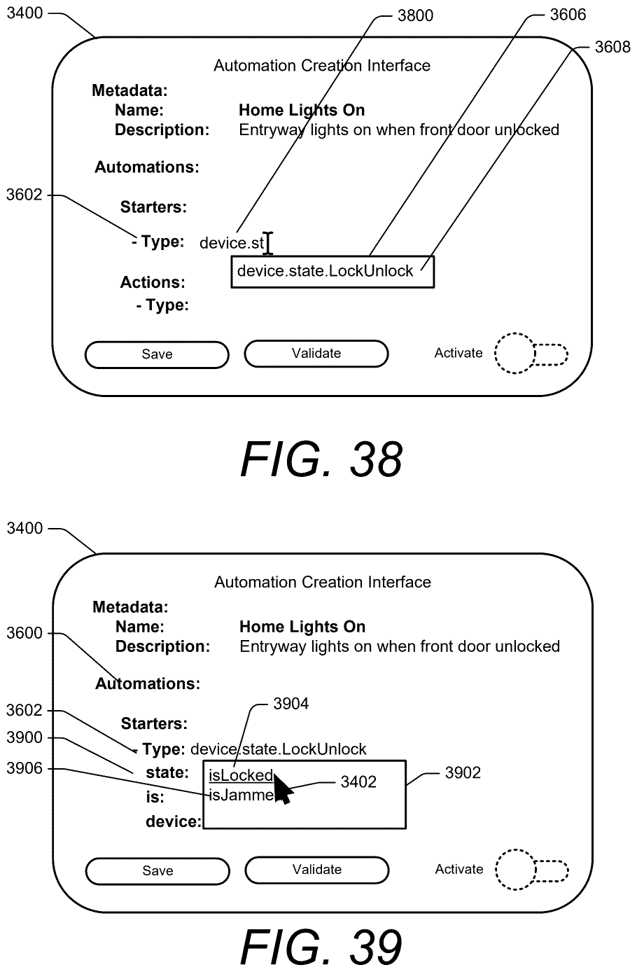

FIG. 37 illustrates the user utilizing the cursor 3402 to select the device.state.Lock.Unlock trigger 3608. As illustrated, selecting the device. state. Lock. Unlock trigger 3608 results in a highlighted device.state.Lock.Unlock trigger 3700 (shown as an underline) to confirm the user's selection. FIG. 38 illustrates the user typing out the device.state.Lock.Unlock trigger 3608. As illustrated, instead of using the cursor 3402 to select the device.state.Lock.Unlock trigger 3608 from the starter menu 3604 as shown in FIG. 37, after selecting the type input 3602, a user may begin typing text 3800 of the desired trigger at the type input 3602. In implementations, as the user types, triggers from the starter menu 3604 are filtered to triggers that match the typed text 3800. Thus, for a knowledgeable user familiar with available triggers, particularly when the device management system (e.g., device management system 3200) includes many network-connected devices with many available triggers, it may be more efficient to enter the typed text 3800 than to scroll through many screens of available triggers included in the starter menu 3604. Once the starter menu 3604 has been filtered by the type text 3800, the user may select the desired device.state.Lock.Unlock trigger 3608 using the cursor 3402.

Once the desired device.state.Lock.Unlock trigger 3608 is selected, referring to FIG. 39, a state input 3900 and a state menu 3902 appear. The state input 3900 and the state menu 3902 appear because the device.state.Lock.Unlock trigger 3608 recognizes more than one state including, for example, an isLocked state 3904 and an isJammed state 3906. The user manipulates the cursor 3402 to select the isLocked state 3904.

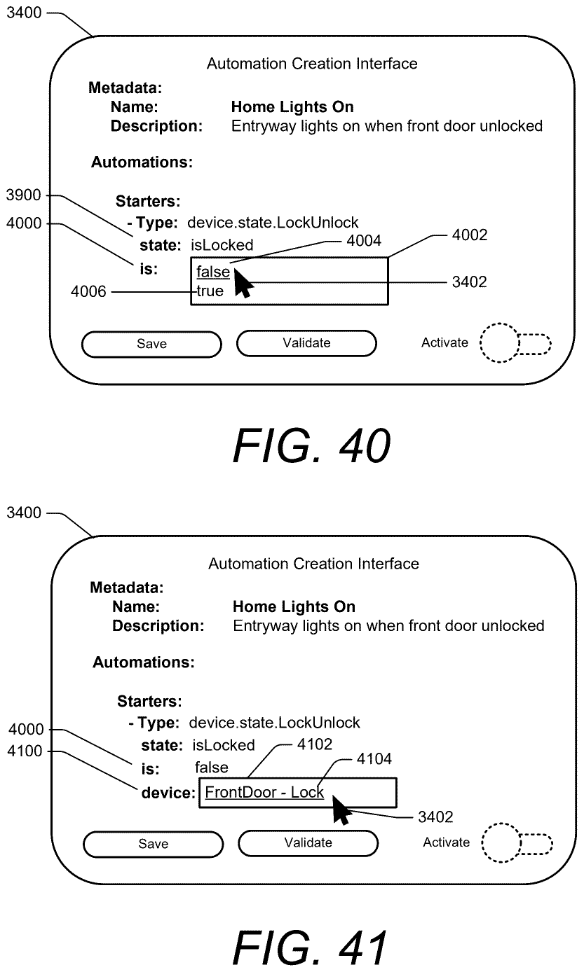

Referring to FIG. 40, having selected a state, the isLocked state 304 that itself has two further potential statuses—locked or unlocked—a status or is state input 4000 and a status menu 4002 are presented under the state input 3900. The status menu 4002 includes two options, a false option 4004 (which, for the isLocked state 3904 means the corresponding lock is unlocked) and true option 4006 (which, for the isLocked state 3904 means the corresponding lock is locked). Utilizing the cursor 3402, the user selects the false option 4004 so that the automation routine is responsive to the corresponding lock being unlocked. Referring to FIG. 41, responsive to the user selecting a state from the state input 4000, a device input 4100 and a device menu 4102 are presented beneath the state input 4000 from which the user is able to select the lock device whose status is to trigger the automation routine. In this case, the device menu 4102 includes only one option, a “FrontDoor—Lock” device 4104 because the home property 102 includes only one network-connected locking device, the lock 126. The user may, using the cursor 3402, confirm the desire to select the “FrontDoor—Lock” device 4104.

Thus, for a starter input for the automation routine, the user has selected a trigger of the lock 126 on at the front door 110 being unlocked. Although the process of selecting this trigger seems detailed, it will be appreciated that the user could select this trigger merely by engaging the automation creation interface screen 3400 and making some selections with the cursor 3402. The selection was described using several figures to illustrate an example of how the assistive automation creation interface screens 3400 guides the user through the process based on available network-connected devices and their capabilities.

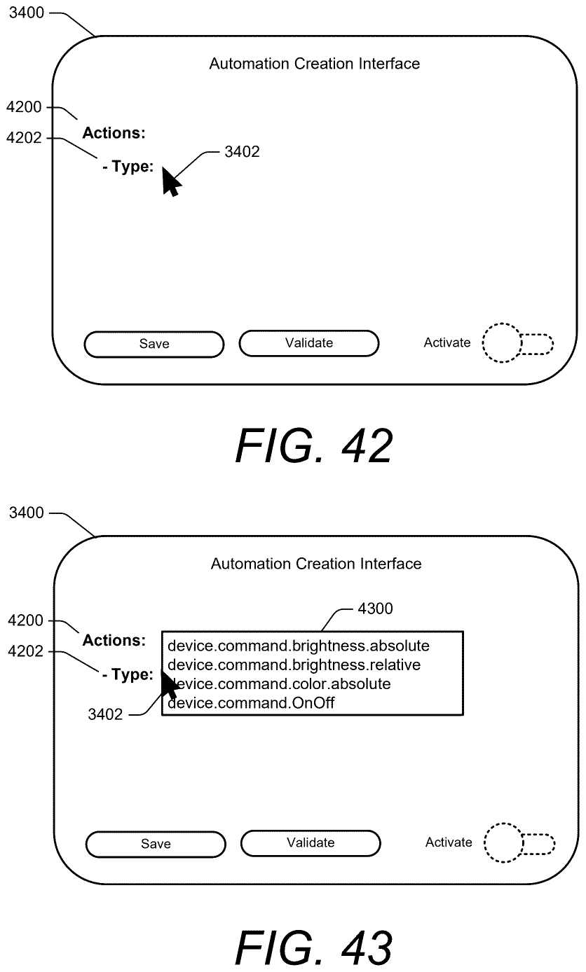

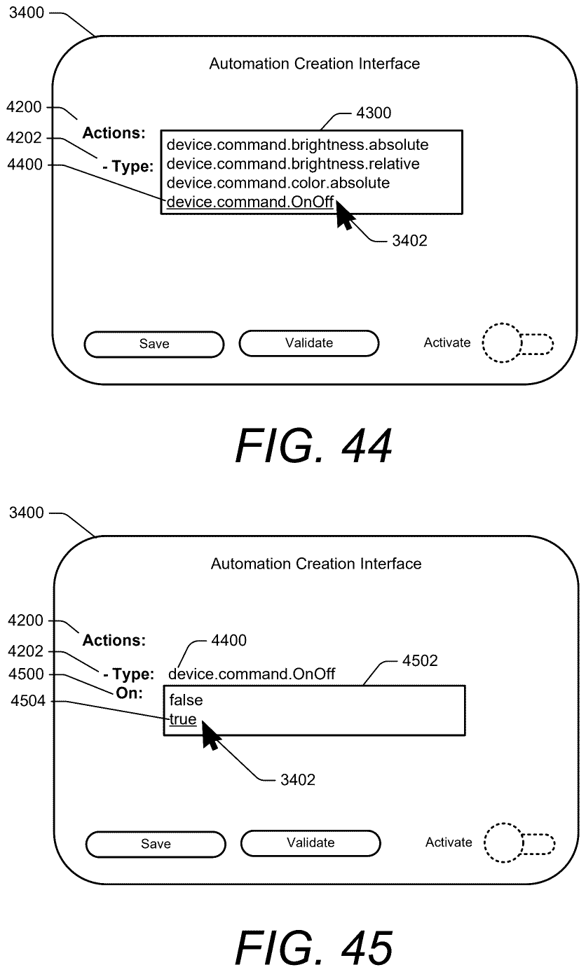

Having selected the trigger of the lock 126 on the front door 110 being unlocked, the user now selects what actions will be initiated by the selected trigger. Referring to FIG. 42, another aspect of the automation creation interface screen 3400 presents an action input 4200 to elicit the desired one or more actions. The user may begin the process of choosing a selected action by using the cursor 3402 to select a type input 4202 to select a type of action to be performed. Referring to FIG. 43, similar to other user inputs as previously described, by manipulating the cursor 3402 to select the type input 4202, a type menu 4300 is presented listing available action types. Referring to FIG. 44, from the type menu 4300, the user manipulates the cursor 3402 to select a “device.command.OnOff” type 4400.

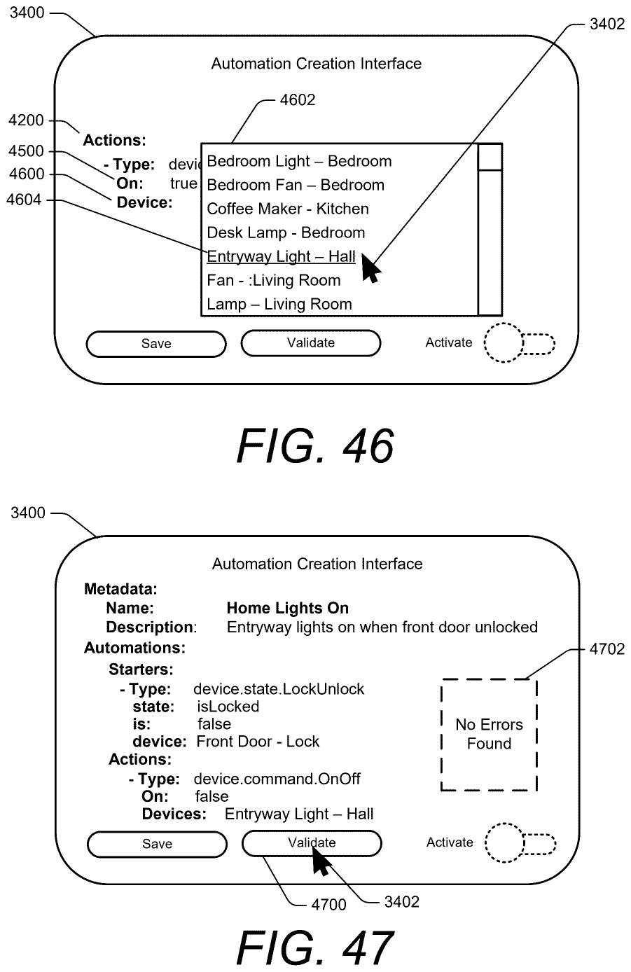

With the device.command.OnOff type 4400 selected, referring to FIG. 45, the assistive automation creation interface screen 3400 presents an on input 4500 and an on menu 4502 allowing the user to select the desired state of the selection action type. The user manipulates the cursor 3402 to select a “true” state 4504 to specify that the desired action for the device.command.OnOff type 4400 selected is to turn the device on. Referring to FIG. 46, with the device.command.OnOff type 4400 and the true state 4504 selected, a last selection is that of the device to be powered on. Selection of the device.command.OnOff type 4400 and the true state 4504 presents a device input 4600 beneath the on input 4500 and a device menu 4602 that includes all of the devices that could be turned on as selected. From the device menu 4602, the user manipulates the cursor to select the “Entry Way Light—Hall” 4604. This finishes the selection process of the automation routine.

Referring to FIG. 47, to further assist a user in creating an automation routine, the automation creation interface screen 3400 also presents a validate option 4700 which tests the combination of inputs to determine whether the user has entered a valid combination of starter and action inputs. The validate option 4700 simulates the occurrence of the selected starter and the selected action to determine if the device management system (see FIG. 32) could execute the action in response to occurrence of the trigger named in the action selection. Thus, the user may use the cursor 3402 to select the validate option 4700 and, if the inputs present a viable automation routine, the automation creation interface screen 3400 presents a no errors found message 4702. The entered automation routine then may be used. Although not shown, if the validate option 4700 determines that the combination of triggers and actions does not present a valid automation routine, an error message, including identification of the potential erroneous input may be provided.

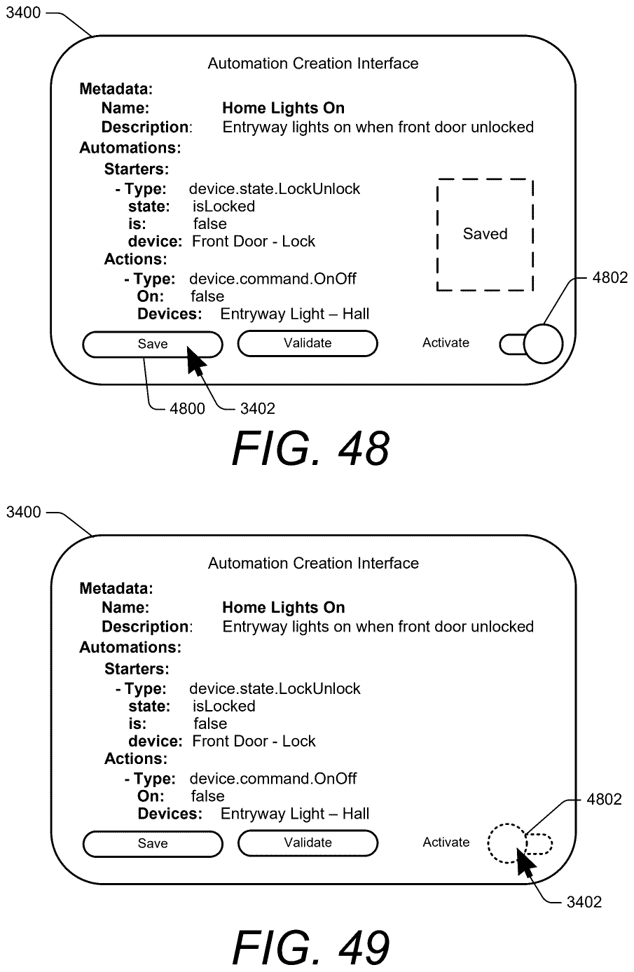

Referring to FIG. 48, once the routine has been validated by the automation creation system 3202 (see FIG. 32), the user may utilize the cursor 3402 to select a save option 4800. The save option 4800 saves the input provided by the user as described with reference to FIGS. 34-46 and automatically activates the automation routine created by the user. The automation creation interface screen 3400 includes an activate option 4802 that the user can toggle by selecting it with the cursor 3402. In implementations, the automation creation system 3202 is configured to automatically validate an automation routine when it is saved by engaging the save option 4800 without the user having to select the activate option 4802. Referring to FIG. 49, if the user wishes for the automation routine not to be activated, the user can toggle the activate option 4802 to deactivate the automation routine.

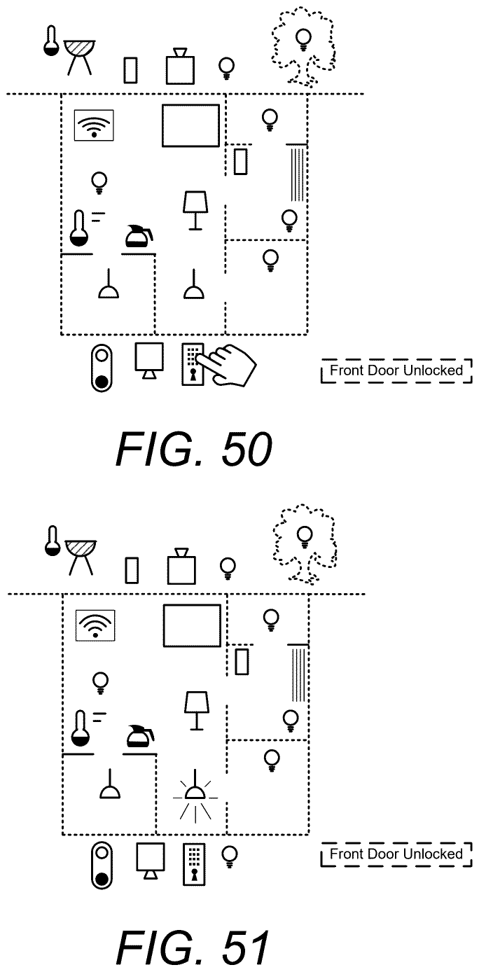

FIGS. 50 and 51 illustrate an example operation of the automation routine created and activated as described with reference to FIGS. 34-48. Referring to FIG. 50, the lock 126 at the front door 110 is unlocked using a key code, a key, or a wireless signal transmitted to the lock. Referring to FIG. 51, in response to the lock 126 being unlocked, the entryway light 128 is turned on (as indicated by radiant lines extending from the entryway light in FIG. 51).

It will be appreciated that the routine of turning on the entryway light 128 when the lock 126 is unlocked is more useful at nighttime than during the day. Implementations of the automation creation system 3202 thus, in addition to creating automations with starters and triggers, also allows for conditions to be selected that may be used to qualify whether an action is performed once an occurrence of a trigger fulfills the starter considerations. Thus, continuing with the example of turning on the entryway light 128 when the lock 126 is unlocked, the user wishes to add conditions such that the entryway light 128 is turned on at nighttime when the lock 126 is unlocked at nighttime, i.e., before sunrise and after sunset.

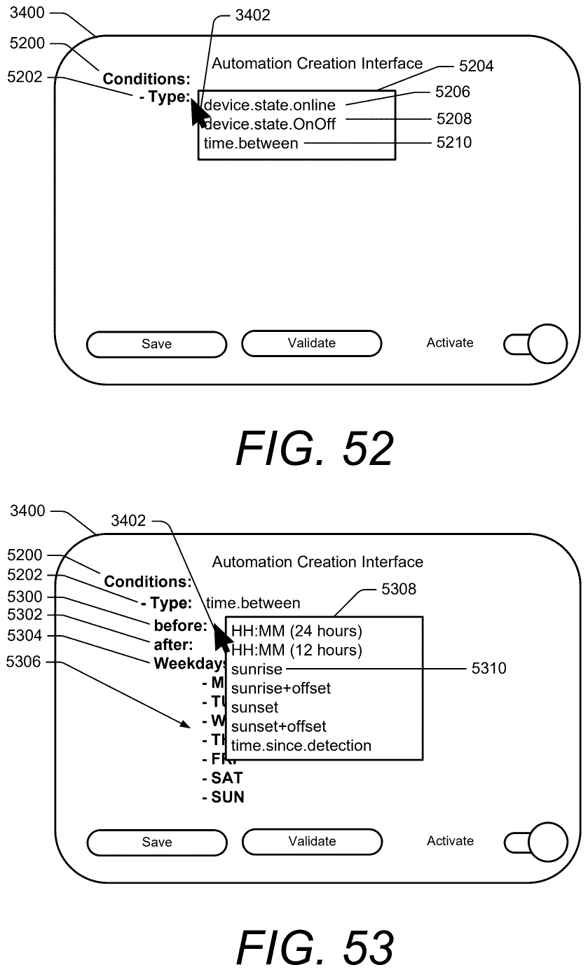

Referring to FIG. 52, using the same starter input at the starter input 3600 and customized as described with reference to FIGS. 36-41 and the same actions input at the action input 4200 and customized as described with reference to FIGS. 42-47, a condition is created at a condition input 5200. The user may utilize the cursor 3402 to engage a type input 5202 which, as previously described with selecting starters and actions, presents a conditions menu 5204. In implementations, the conditions menu 5204 is context-dependent and, thus, presents conditions that are relevant to the starter previously selected. Thus, the conditions menu 5204 provides selections between a device. state. online option 5206, a device.state.OnOff option 5208, and a time. between option 5210 that may restrict a selected action for a starter related to the lock being unlocked. The time.between option 5210 is relevant to the user's desire to have the automation routine turn on the entryway light 128 only at night when the lock 126 is unlocked, so the time. between option 5210 is selected.

Referring to FIG. 53, in response to the time. between option 5210 being selected, the automation creation interface screen 3400 presents additional inputs for “before” 5300, “after” 5302, and which days 5304, which may include weekdays 5306 or one or more specific days 5308. Thus, the user can specify the times at which the action will be performed in response to the starter's identified trigger occurring and, if desired, on which days. Accordingly, selecting the option “sunrise” 5310 for the before input 5300 will specify an end time for the automation routine to be executed when the lock 126 is unlocked. Although not shown, the user similarly can manipulate the cursor 3402 to engage the “after” input 5304 and choose from a menu presented a sunset option so that the automation routine will be executed when the lock 126 is unlocked only between sunset and sunrise-when the automatic turning on of the entryway light will be most welcome. Thus, the providing of a conditions input 5200 by the automation creation interface screen 3400 allows the user to tailor criteria at which an action will be performed in response to occurrence of a trigger specified in the starter input.

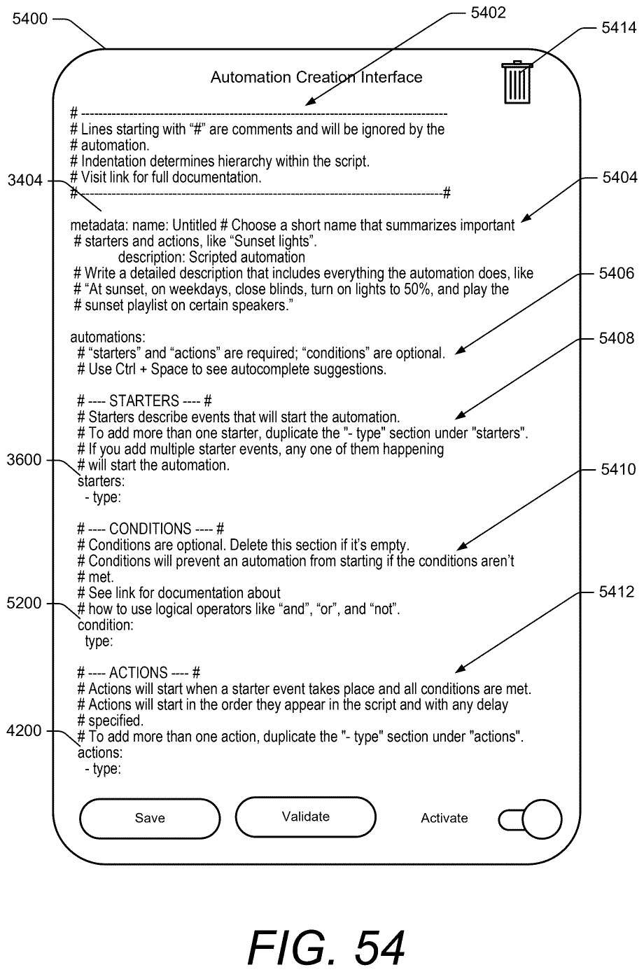

FIG. 54 illustrates an example annotated automation creation interface including instructions and default parameters. For ease of use, the automation creation interface screen 3400 may be annotated with instructions in comments fields and presenting all the possible inputs as shown in FIG. 54 in an annotated automation creation interface screen 5400. The annotated automation creation interface screen 5400 includes the metadata input 3404, the starter input 3600, the actions input 4200, and the conditions input 5200, as well as initial instructions 5402, metadata instructions 5404, automations instructions 5406, starters instructions 5408, conditions instructions 5410, and the actions instructions 5412. In addition to the menus and other features previously described, the instructions 5402, 5404, 5406, 5408, 5410, and 5412 provide a user with relevant instructions on all the inputs to guide the user in entering an automation routine. It is noted that the initial instructions 5402 point out that the conditions input 5200 is included, but by prefacing the conditions input 5200 with a comment delimiter, such as “#,” will cause the conditions input to be treated as a comment and ignored. The annotated automation creation interface screen 5400 thus further aids a user in presenting all the needed inputs without the user having to type in, for example, the conditions statements; instead, the user can use the prepopulated conditions input or cause it to be ignored by typing a single character before each line that is not to be used. In implementations, as shown on the annotated automation creation interface screen 5400, a discard option 5214 may be included so that a user can scrap an automation routine that the user has created.

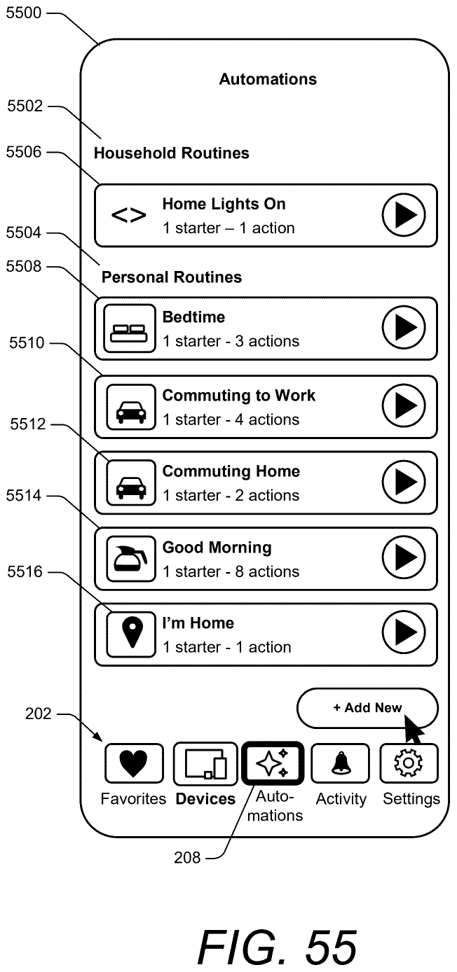

FIG. 55 illustrates an example automations screen including the automation routine created as described with reference to FIGS. 34-49, 52, and 53. As previously described, interfaces on the client device 162 present a set of tabs 202 that includes the automations tab 208 that a user may engage to access an automations screen 5500. The automations screen 5500 includes a section for household routines 5502 available to all users as well personal routines 5504 solely for a particular user. The automations included in the household routines 5502 and the personal routines 5504 may include user-created automations, such as the home lights on automation 5506 that was created by the user as described with reference to FIGS. 34-54. The other automations 5508, 5510, 5512, 5514, and 5516 may include other user-created automations or pre-scripted automations. From the automations screen 5500, the user may select the add new button to access the automation creation interface 3400 used in creating the home lights on automation 5506 as described with reference to FIGS. 34-49 and 52-54.

### Example Methods

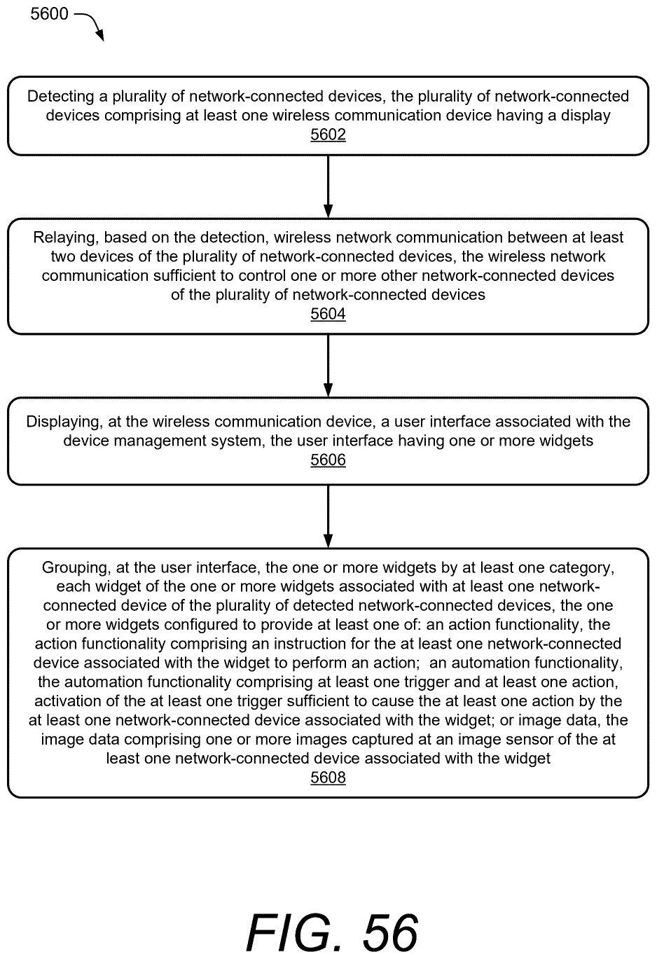

FIG. 56 illustrates an example method 5600 for a device management system as described with reference to FIGS. 1-16B. At block 5602, a plurality of network-connected devices are detected, the plurality of network-connected devices comprising at least one wireless communication device having a display. At block 5604, based on the detection, wireless network communication is relayed between at least two devices of the plurality of network-connected devices, with the wireless network communication sufficient to control one or more other network-connected devices of the plurality of network-connected devices. Here, the term “the wireless network sufficient to control” can be replaced by “the wireless network controls”. At block 5606, at the client device 162, a user interface associated with the device management system is displayed, the user interface having (comprising) one or more widgets. The one or more widgets enable the user to access and/or control the network-connected devices associated with one or more of the widgets. At block 5608, at the user interface, the one or more widgets are grouped by at least one category, where each widget of the one or more widgets associated with at least one network-connected device of the plurality of detected network-connected devices. Such a grouping can enable the user to manage a technical task, such as obtaining data from a network connected device, and controlling the network connected device in a more efficient and faster manner. The step of “grouping” defined at block 5608 can be considered as optional, and is hence not necessary for conducting method 5600. The one or more widgets are configured to provide at least one of: an action functionality, the action functionality comprising an instruction for the at least one network-connected device associated with the widget to perform an action; an automation functionality, the automation functionality comprising at least one trigger and at least one action, activation of the at least one trigger sufficient to cause the at least one action by the at least one network-connected device associated with the widget; or image data, the image data comprising one or more images captured at an image sensor of the at least one network-connected device associated with the widget. These functionalities can be controlled and/or initiated by the user by providing user input to the user interface.

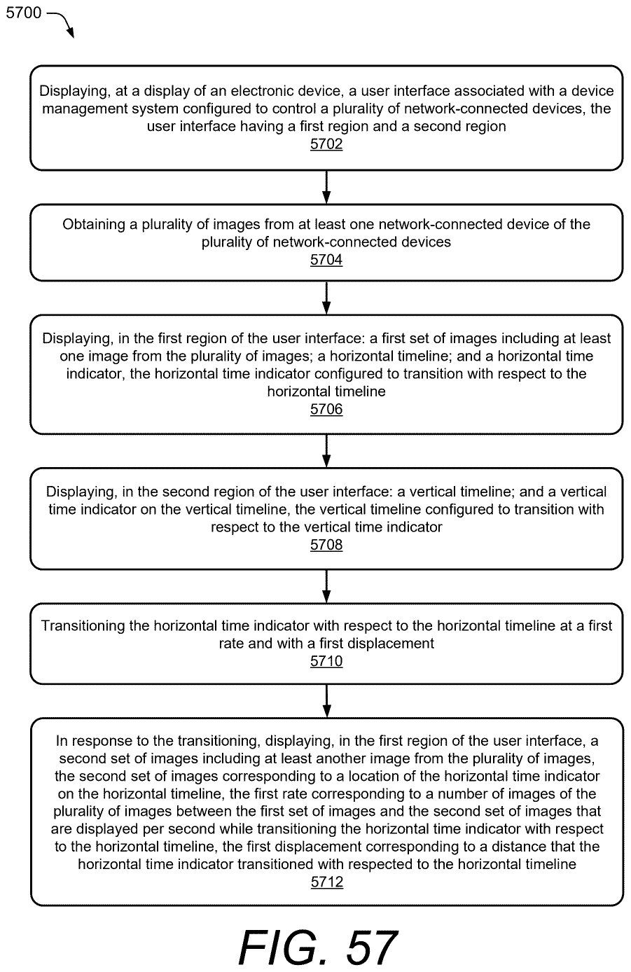

FIG. 57 illustrates an example method 5700 of controlling a display of images obtained from at least one network-connected device as described with reference to FIGS. 17-31. At block 5702, the device management system displays a user interface (e.g., the video-playback interface) at a display of an electronic device. The user interface includes a first region and a second region. At block 5704, a plurality of images are obtained from at least one network-connected device of the plurality of network-connected devices. At block 5706, the device management system displays, in the first region of the user interface, (i) a first set of images including at least one image from the plurality of images, (ii) a horizontal timeline, and (iii) a horizontal time indicator, the horizontal time indicator configured to transition with respect to the horizontal timeline. At block 5708, the device management system displays, in the second region of the user interface, (i) a vertical timeline and (ii) a vertical time indicator on the vertical timeline. The vertical timeline is configured to transition with respect to the vertical time indicator. Also, a user input may be received at the user interface from a user engaging the vertical timeline to move the vertical timeline, and based on the received user input the vertical timeline can be moved. At block 5710, the horizontal time indicator is transitioned with respect to the horizontal timeline at a first rate and with a first displacement. At block 5712, in response to the transitioning, device management system displays, in the first region of the user interface, a second set of images, including at least another image from the plurality of images. The second set of images correspond to a location of the horizontal time indicator on the horizontal timeline. The first rate corresponds to a number of images of the plurality of images between the first set of images and the second set of images that are displayed per second while transitioning the horizontal time indicator with respect to the horizontal timeline. The first displacement corresponds to a distance that the horizontal time indicator transitioned with respect to the horizontal timeline.

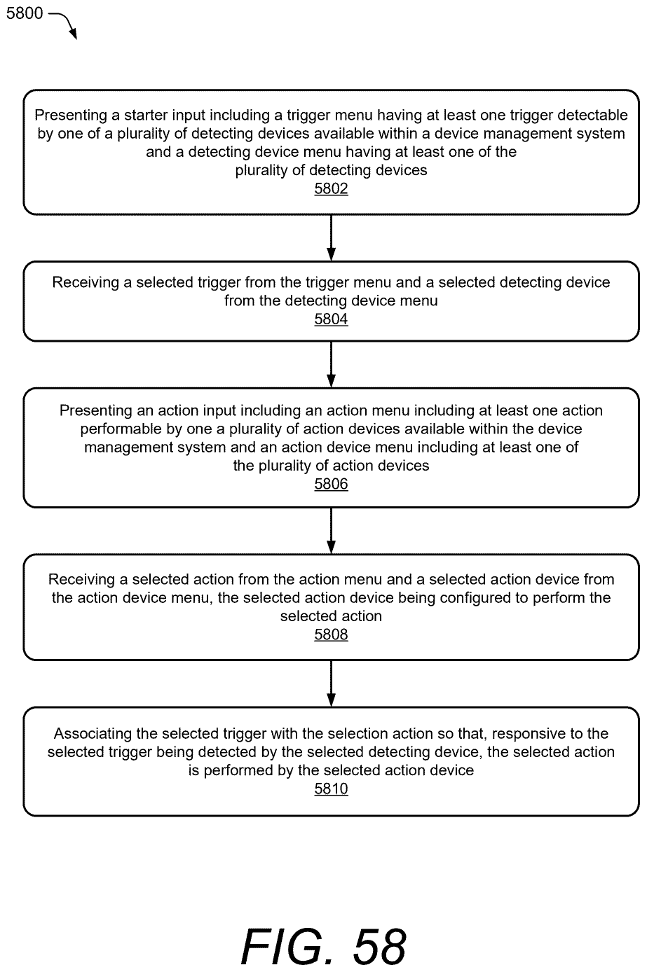

FIG. 58 illustrates an example method 5800 of receiving an automation routine via an automation creation interface. At block 5802, a starter input is presented including a trigger menu including at least one trigger detectable by one of a plurality of detecting devices available within a device management system, and a detecting device menu including at least one of the plurality of detecting devices. The starter menu can be presented, e.g. displayed, on a display or a screen such as an automation creation interface screen. The trigger menu can comprise one or more triggers to initiate a particular action of one or more network-connected devices. The detecting devices can be devices from which data can detected. The detecting device menu can include one or more of the plurality of detecting devices. At block 5804, a selected trigger is received from the trigger menu and a selected detecting device is received from the detecting device menu, the selected detecting device being responsive to the selected trigger. The trigger can be selected by a user of the device management system. At block 5806, an action input is presented, e.g. presented on the display, including an action menu including at least one action performable by one of a plurality of action devices available within the device management system and an action device menu including at least one of the plurality of action devices. In implementations, an action device can be a device adapted to perform one or more actions. The selection of the action menu can take place based on the selected input. At block 5808, a selected action, e.g. from the user, is received from the action menu and a selected action device is received from the action device menu, the selected action device being configured to perform the selected action. At block 5810, the selected trigger is associated with the selection action so that, responsive to the selected trigger being detected by the selected detecting device, the selected action is performed by the selected action device. Based on associating the selected trigger with the selected action, a command can be sent to the selected action device to perform the selected action.

Further to the descriptions above, a user may be provided with controls allowing the user to make an election as to both if and when systems, programs, or features described herein may enable collection of user information (e.g., information about a user's social network, social actions, social activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over what information is collected about the user, how that information is used, and what information is provided to the user.

### ADDITIONAL EXAMPLES

In the following section, additional examples are provided.

Example 1: A method of a device management system, the method comprising: detecting a plurality of network-connected devices, the plurality of network-connected devices comprising at least one wireless communication device having a display; relaying, based on the detection, wireless network communication between at least two devices of the plurality of network-connected devices, the wireless network communication sufficient to control one or more other network-connected devices of the plurality of network-connected devices; displaying, at the wireless communication device, a user interface associated with the device management system, the user interface having one or more widgets; and grouping, at the user interface, the one or more widgets by at least one category, each widget of the one or more widgets associated with at least one network-connected device of the plurality of detected network-connected devices, the one or more widgets configured to provide at least one of: an action functionality, the action functionality comprising an instruction for the at least one network-connected device associated with the widget to perform an action; an automation functionality, the automation functionality comprising at least one trigger and at least one action, activation of the at least one trigger sufficient to cause the at least one action by the at least one network-connected device associated with the widget; or image data, the image data comprising one or more images captured at an image sensor of the at least one network-connected device associated with the widget.

Example 2: The method of example 1, wherein the user interface associated with the device management system comprises a plurality of tabs, at least one tab of the plurality of tabs comprising at least one control tile and a first category having a first set of widgets.

Example 3: The method of example 2, wherein the first category comprises a favorites category, and wherein the first set of widgets comprise one or more user-selected widgets, suggested widgets, or frequently-used widgets.

Example 4: The method of example 2, wherein the at least one control tile comprises quick access to at least one of metadata or control options associated with at least one device of the plurality of network-connected devices.

Example 5: The method of example 4, wherein the at least one control tile comprises a camera control tile and the at least one device of the plurality of network-connected devices comprises at least one camera, the camera control tile configured to provide quick access to at least one of metadata or controls associated with the at least one camera.

Example 6: The method of example 5, wherein: the metadata comprises a location indicator, and a time indicator for one or more images captured at the at least one camera; and the controls comprise activating the at least one camera, zooming with the at least one camera, powering off the at least one camera, or reviewing one or more images captured by the at least one camera.

Example 7: The method of example 4, wherein the at least one control tile comprises a lighting control tile and the at least one device of the plurality of network-connected devices comprises at least one lighting device, the lighting control tile configured to provide quick access to at least one of metadata or controls associated with the at least one lighting device.

Example 8: The method of example 7, wherein the metadata comprises at least one of an on-time duration, an age, a color, a color temperature, or a brightness of the at least one lighting device; and the controls comprise at least one of activating the at least one lighting device, adjusting a brightness of the at least one lighting device, adjusting a color of the at least one lighting device, adjusting a color of the at least one lighting device, or powering off the at least one lighting device.

Example 9: The method of any one of examples 1-8, further comprising: receiving, at the user interface, user input indicative of an interaction with a respective widget of the one or more widgets, the interaction comprising at least one: a sliding input at the respective widget, the sliding input configured to adjust a value sufficient to instruct at least one network-connected device associated with the respective widget to increase or decrease an output; a tapping input at the respective widget, the tapping input configured to enable or disable the respective widget sufficient to instruct at least one network-connected device associated with the respective widget to activate or deactivate; or a selection input at the respective widget, the selection input configured to access metadata of at least one network-connected device associated with the respective widget.

Example 10: The method of any one of examples 1-9, wherein the user interface associated with the device management system further comprises a media streaming control, the media streaming control configured to receive user input to direct at least one network-connected device of the plurality of network-connected devices.

Example 11: The method of example 1, further comprising: receiving, at the user interface, user input indicative of a selection to move one or more widgets within the at least one category.

Example 12: The method of example 1, wherein a respective category of the at least one category comprises a first widget, a second widget, and a third widget, the first widget configured to provide the automation functionality, the second widget configured to provide the action functionality, and the third widget configured to provide image data.

Example 13: The method of any one of examples 1-12, wherein the at least one trigger comprises a scheduled time or a detected event.

Example 14: A system comprising means for performing a method of any one of examples 1 through 13.

Example 15: A program for causing a computer to execute the method recited in any one of examples 1 through 13.

Example 16: A method comprising: displaying, at a display of an electronic device, a user interface associated with a device management system configured to control a plurality of network-connected devices, the user interface having a first region and a second region; obtaining a plurality of images from at least one network-connected device of the plurality of network-connected devices; displaying, in the first region of the user interface: a first set of images including at least one image from the plurality of images; a horizontal timeline; and a horizontal time indicator, the horizontal time indicator configured to transition with respect to the horizontal timeline; displaying, in the second region of the user interface: a vertical timeline; and a vertical time indicator on the vertical timeline, the vertical timeline configured to transition with respect to the vertical time indicator; transitioning the horizontal time indicator with respect to the horizontal timeline at a first rate and with a first displacement; and in response to the transitioning, displaying, in the first region of the user interface, a second set of images including at least another image from the plurality of images, the second set of images corresponding to a location of the horizontal time indicator on the horizontal timeline, the first rate corresponding to a number of images of the plurality of images between the first set of images and the second set of images that are displayed per second while transitioning the horizontal time indicator with respect to the horizontal timeline, the first displacement corresponding to a distance that the horizontal time indicator transitioned with respect to the horizontal timeline.

Example 17: The electronic device of example 16, further comprising: in response to transitioning the horizontal indicator, transitioning the vertical timeline with respect to the vertical time indicator at a second rate and a second displacement, the second rate equivalent to the first rate, the second displacement corresponding to a distance that the vertical timeline transitions with respect to the vertical time indicator, and wherein the second displacement is greater than first displacement sufficient to provide a high-resolution scroll.

Example 18: The electronic device of example 16, further comprising: identifying at least one event in the plurality of images; displaying, in response to identifying the at least one event, an event indicator for each event of the at least one event.

Example 19: The electronic device of example 18, wherein a respective event indicator comprises a graphical object having a length parallel to the vertical timeline, the length representing a duration of an associated event.

Example 20: The electronic device of example 18, wherein one or more intervals on the vertical timeline are condensed to shorten space between event times that are associated with identified events.

Example 21: The electronic device of example 18, further comprising: displaying in the second region of the user interface a thumbnail for one or more events of the at least one event, and wherein the thumbnail comprises an image from the plurality of images.

Example 22: The electronic device of example 21, wherein the image comprises at least one of (i) an image captured proximate in time to an occurrence of an associated event, (ii) a representative image captured during the occurrence of the associated event, or (iii) a composite image generated from two or more images captured during the occurrence of the associated event.

Example 23: The electronic device of example 16, further comprising: receiving, at the second region of the user interface, a user input transitioning the vertical timeline with respect to the vertical time indicator; and transitioning the horizontal time indicator with respect to the horizontal timeline.

Example 24: The electronic device of example 23, further comprising: in response to transitioning the horizontal time indicator, displaying, in the first region of the user interface, a third set of images including at least another image from the plurality of images, the third set of images corresponding to a location of the horizontal time indicator on the horizontal timeline.

Example 25: The electronic device of example 16, wherein: the vertical time indicator configured to transition with respect to the vertical timeline provides a low-resolution scanning through the plurality of images; and the horizontal timeline configured to transition with respect to the horizontal time indicator provides a high-resolution scanning through the plurality of images.

Example 26: The electronic device of claim 16, wherein the user interface comprises a third region, the method further comprising: displaying, in the third region, one or more graphical controls comprising a forward button, a play button, and a backward button.

Example 27: The electronic device of example 26, further comprising: identifying a first event in the plurality of images, the first event associated a third set of images, and wherein the horizontal time indicator is positioned on the horizontal timeline before an occurrence of the first event; receiving, at the third region of the user interface, a first user input to advance the plurality of images; transitioning the horizontal time indicator with respect to the horizontal timeline and the vertical timeline with respect to the vertical time indicator, the transitioning sufficient to advance the horizontal time indicator with respect to the horizontal timeline and the vertical timeline with respect to the vertical time indicator; and displaying at least one image from the third set of images associated with the first event.

Example 28: The electronic device of example 26, further comprising: identifying a first event in the plurality of images, the first event associated with a third set of images, and wherein the horizontal time indicator is positioned on the horizontal timeline after an occurrence of the first event; receiving, at the third region of the user interface, a first user input selecting the backward button; transitioning the horizontal time indicator with respect to the horizontal timeline and the vertical timeline with respect to the vertical time indicator, the transitioning sufficient to reverse the horizontal time indicator with respect to the horizontal timeline and the vertical timeline with respect to the vertical time indicator; and displaying at least one image from the third set of images associated with the first event.

Example 29: A system comprising means for performing a method of any one of examples 16 through 28.

Example 30: A program for causing a computer to execute the method recited in any one of examples 16 through 28.

Example 31: A method of a device management system, the method including: presenting a starter input, the starter input including: a trigger menu having at least one trigger detectable by one of a plurality of detecting devices available within the device management system; and a detecting device menu including at least one of the plurality of detecting devices; receiving a selected trigger from the trigger menu and a detecting device selection from the detecting device menu; presenting an action input, the action input comprising: an action menu including at least one action performable by one of a plurality of action devices available within the device management system; and an action device menu including at least one of the plurality of action devices; receiving a selected action from the action menu and an action device selection from the action device menu, the selected action device configured to perform the selected action; and associating the selected trigger with the selected action such that, responsive to the selected trigger being detected by the selected detecting device, the selected action is performed by the selected action device.

Example 32: The method of claim 31, further comprising: populating the trigger menu with one or more triggers to which at least one of the plurality of detecting devices available within the device management system are responsive; and populating the action menu with one or more actions performable by at least one of the plurality of action devices available within the device management system.

Example 33: The method of example 31, further comprising, responsive to a text string corresponding to part of a name of one of the plurality of detecting devices available or one of the plurality of action devices available, presenting a list of the plurality of devices matching the text string from which one of the list is selectable.

Example 34: The method of example 31, further comprising, responsive to receiving the selected trigger from the trigger menu, tailoring the detecting device menu to one or more capable detecting devices configured to be responsive to the selected trigger.

Example 35: The method of example 31, further comprising receiving a selected state of the selected trigger to be determined as a prerequisite of the selected action being performed by the selected action device.

Example 36: The method of example 35, further comprising, responsive to receiving the selected trigger from the trigger menu, presenting a state menu listing one or more states of the selected trigger from which the selected state is selectable.

Example 37: The method of example 35, wherein the selected state detectable by the detecting device includes at least one of: a time; an event; a voice command; a recognized or an unrecognized face; a lock being locked or unlocked; a light being on or off; and a temperature.

Example 38: The method of example 31, further comprising receiving a selected attribute of the selected action.

Example 39: The method of example 38, further comprising, responsive to receiving the selected action, presenting an attribute menu listing one or more attributes of the selection action from which the selected attribute is selectable.

Example 40: The method of example 38, wherein the selected attribute includes at least one of: assuming an on state or an off state; changing a brightness of a light; changing a color or a color temperature of a light; a camera position setting or zoom setting; a media selection playable by a media player; or a position of a blind playback operation.

Example 41: The method of example 31, wherein at least one of the device management system presenting the automation creation interface, the list of the plurality of detecting devices available within the device management system, and the plurality of action devices available within the device management system are maintained in a remote computing system.

Example 42: The method of example 31, further comprising: presenting a condition input, the condition input configured to receive a user selection from a condition list including condition combinations of detectable conditions and a state of the condition, wherein responsive to the trigger being detected by the at least one detecting device, the at least one action device performs the action when the state of the condition is detected.

Example 43: The method of example 31, further comprising validating the automation routine to determine if the automation routine is free of errors.

Example 44: A system comprising means for performing a method of any one of examples 31 through 43.

Example 45: A program for causing a computer to execute the method recited in any one of examples 31 through 43.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques for a customizable user interface for a device management system have been described in language specific to certain features and/or methods, the subject of the appended claims is not necessarily limited to the specific features or methods described. Rather, the specific features and methods are disclosed as example implementations of the described systems and techniques.

1. A method of a device management system, the method comprising:
presenting a starter input, the starter input comprising:
a trigger menu including at least one trigger detectable by one of a plurality of detecting devices available within the device management system; and
a detecting device menu including at least one of the plurality of detecting devices;
receiving a selected trigger from the trigger menu and a detecting device selection from the detecting device menu;
presenting an action input, the action input comprising:
an action menu including at least one action performable by one of a plurality of action devices available within the device management system; and
an action device menu including at least one of the plurality of action devices;
receiving a selected action from the action menu and an action device selection from the action device menu, the selected action device configured to perform the selected action; and
associating the selected trigger with the selected action such that, responsive to the selected trigger being detected by the selected detecting device, the selected action is performed by the selected action device.

2. The method of claim 1, further comprising:
populating the trigger menu with one or more triggers to which at least one of the plurality of detecting devices available within the device management system are responsive; and
populating the action menu with one or more actions performable by at least one of the plurality of action devices available within the device management system.

3. The method of claim 1, further comprising, responsive to a text string corresponding to part of a name of one of the plurality of detecting devices available or one of the plurality of action devices available, presenting a list of the plurality of devices matching the text string from which one of the list is selectable.

4. The method of claim 1, further comprising, responsive to receiving the selected trigger from the trigger menu, tailoring the detecting device menu to include one or more detecting devices capable of detecting the selected trigger.

5. The method of claim 1, further comprising receiving a selected state of the selected trigger to be determined as a prerequisite of the selected action being performed by the selected action device.

6. The method of claim 5, further comprising, responsive to receiving the selected trigger from the trigger menu, presenting a state menu listing one or more states of the selected trigger from which the selected state is selectable.

7. The method of claim 5, wherein the selected state detectable by the detecting device includes at least one of:
a time;
an event;
a voice command;
a recognized or an unrecognized face;
a lock being locked or unlocked;
a light being on or off; and
a temperature.

8. The method of claim 1, further comprising receiving a selected attribute of the selected action.

9. The method of claim 8, further comprising, responsive to receiving the selected action, presenting an attribute menu listing one or more attributes of the selection action from which the selected attribute is selectable.

10. The method of claim 8, wherein the selected attribute includes at least one of:
assuming an on state or an off state;
changing a brightness of a light;
changing a color or a color temperature of a light;
a camera position setting or zoom setting;
a media selection playable by a media player; or
a position of a blind playback operation.

11. The method of claim 1, wherein at least one of the device management system presenting an automation creation interface, a list of the plurality of detecting devices available within the device management system, and the plurality of action devices available within the device management system are maintained in a remote computing system.

12. The method of claim 1, further comprising presenting a condition input, the condition input configured to receive a user selection from a condition list including condition combinations of detectable conditions and a state of the condition, wherein responsive to the trigger being detected by the at least one detecting device, the at least one action device performs the action when the state of the condition is detected.

13. The method of claim 1, further comprising validating an automation routine, the validation sufficient to determine if the automation routine is free of errors.

14. A computer-readable storage medium comprising instructions that, when executed by one or more processors, configure at least one processor of the one or more processors to:
present a starter input, the starter input comprising:
a trigger menu including at least one trigger detectable by one of a plurality of detecting devices available within a device management system; and
a detecting device menu including at least one of the plurality of detecting devices;
receive a selected trigger from the trigger menu and a detecting device selection from the detecting device menu;
present an action input, the action input comprising:
an action menu including at least one action performable by one of a plurality of action devices available within the device management system; and
an action device menu including at least one of the plurality of action devices;
receive a selected action from the action menu and an action device selection from the action device menu, the selected action device configured to perform the selected action; and
associate the selected trigger with the selected action such that, responsive to the selected trigger being detected by the selected detecting device, the selected action is performed by the selected action device.

15. (canceled)

16. The computer-readable storage medium of claim 14, wherein the instructions, when executed, further configure the at least one processor to:
populate the trigger menu with one or more triggers to which at least one of the plurality of detecting devices available within the device management system are responsive; and
populate the action menu with one or more actions performable by at least one of the plurality of action devices available within the device management system.

17. The computer-readable storage medium of claim 14, wherein the instructions, when executed, further configure the at least one processor to, responsive to a text string corresponding to part of a name of one of the plurality of detecting devices available or one of the plurality of action devices available, present a list of the plurality of devices matching the text string from which one of the list is selectable.

18. The computer-readable storage medium of claim 14, wherein the instructions, when executed, further configure the at least one processor to, responsive to receiving the selected trigger from the trigger menu, tailor the detecting device menu to include one or more detecting devices capable of detecting the selected trigger.

19. The computer-readable storage medium of claim 14, wherein the instructions, when executed, further configure the at least one processor to receive a selected state of the selected trigger to be determined as a prerequisite of the selected action being performed by the selected action device.

20. The computer-readable storage medium of claim 14, wherein at least one of the device management system presenting the automation creation interface, the list of the plurality of detecting devices available within the device management system, and the plurality of action devices available within the device management system are maintained in a remote computing system.

21. The computer-readable storage medium of claim 14, wherein the instructions, when executed, further configure the at least one processor to:
present a condition input, the condition input configured to receive a user selection from a condition list including condition combinations of detectable conditions and a state of the condition, wherein responsive to the trigger being detected by the at least one detecting device, the at least one action device performs the action when the state of the condition is detected; and
validate an automation routine, the validation sufficient to determine if the automation routine is free of errors.
